(19) United States
(12) Patent Application Publication
(10) Pub. No.: US 2025/0192934 A1
(43) Pub. Date: Jun. 12, 2025

(54) UNIFIED BEAM MANAGEMENT FRAMEWORK WITH MULTIPLE BEAMS

(71) Applicant: Fraunhofer-Gesellschaft zur Förderung der angewandten Forschung e.V., MÜNCHEN (DE)

(72) Inventors: Sutharshun Varatharaajan, Erlangen (DE); Marcus Grossmann, Erlangen (DE); Markus Landmann, Erlangen (DE)

(73) Assignee: Fraunhofer-Gesellschaft zur Förderung der angewandten Forschung e.V., MÜNCHEN (DE)

(21) Appl. No.: 18/845,359

(22) PCT Filed: Mar. 8, 2023
(86) PCT No.: PCT/EP2023/055942

§ 371 Date: Sep. 9, 2024

(30) Foreign Application Priority Data
Mar. 8, 2022 (EP) 22160837.5

(51) Int. Cl. H04L 5/00

(52) U.S. Cl. CPC H04L 5/0044; H04L 5/0005

(57) ABSTRACT

A method performed by a user equipment (UE) includes receiving, from a network node via a physical downlink control channel (PDCCH) or a higher layer signaling, a transmission configuration indication (TCI)-state indication for M TCI-states, where M>1. The method may also include applying the M TCI-states to transmission occasion or parts thereof of a physical channel according to a predetermined or indicated mapping of the M TCI-states or applying the M TCI-states to one or more reference signal (RS) resources or one or more RS resource sets according to a predetermined or indicated mapping of the M TCI-states.

### TECHNICAL FIELD

The present disclosure relates to the field of wireless communications, and in particular, to methods and apparatuses for a unified beam management framework with multiple beams, suitable for 5G.

### BACKGROUND

The radio access technology (RAT) in fifth generation (5G) mobile communications system, also known as 5G new radio (NR), provides a higher level of performance and flexibility than the previous generations of mobile communications systems. 5G mobile communications has been driven by the need to provide ubiquitous connectivity for applications as diverse automotive communication, remote control with feedback, video downloads, as well as data applications for Internet-of-Things (loT) devices, machine type communication (MTC) devices, etc. 5G wireless technology brings several main benefits, such as faster speed, shorter delays and increased connectivity. The third-generation partnership project (3GPP) provides the complete system specification for the 5G network architecture, which includes at least a radio access network (RAN), core transport networks (CN) and service capabilities.

In millimeter wave (mmWave) frequencies (frequency range 2 (FR2)), i.e., frequencies above 6 GHz, in general, wireless communication between communication devices is performed with spatially selective/directive transmissions and receptions called beams. Therefore, beam management is a required framework for link establishment, adaptation, and recovery at FR2. In the 3GPP Rel. 16, UL beam management is handled separately for UL channels and reference signals, while in Rel. 17, UL beam management is handled in a unified manner, i.e., a pool of UL or DL/UL transmission configuration indication (TCI) states are configured for a carrier component and a configured TCI-state provides beam transmission setting(s) for the transmission of PUSCH, PUCCH and/or SRS. In Rel. 16, the beam setting(s) are separately configured and/indicated for each of PUCCH, PUSCH and SRS. While the unified TCI/beam management framework is well equipped to handle various single transmit-receive-point (TRP) use-cases, multi-TRP use-cases, which were specified in Rel. 16 and onward, are yet to be addressed using the unified TCI framework. In this invention disclosure, the extension of the unified TCI framework to multi-TRP use-cases is discussed.

The term ‘beam’ is used in the following to denote a spatially selective/directive transmission of an outgoing signal or reception of an incoming signal which is achieved by precoding/filtering the signal at the antenna ports of the device with a particular set of coefficients. The words precoding or filtering may refer to processing of the signal in the analog or digital domain. The set of coefficients used to spatially direct a transmission/reception in a certain direction may differ from one direction to another direction. The term ‘Tx beam’ denotes a spatially selective/directive transmission and the term ‘Rx beam’ denotes a spatially selective/directive reception. The set of coefficients used to precode/filter the transmission or reception is denoted by the term ‘spatial filter’. The term ‘spatial filter’ is used interchangeably with the term ‘beam direction’ in this document as the spatial filter coefficients determine the direction in which a transmission/reception is spatially directed to.

In case of the UE, the ‘spatial relation’ for an UL channel ‘Uc’ or RS ‘Ur’ with respect to or with reference to a DL or UL RS ‘R’ means that the UE uses the spatial filter used to receive or transmit the RS ‘R’ to transmit the UL channel ‘Uc’ or RS ‘Ur’, or it means that the UE uses the spatial filter used to receive or transmit the RS ‘R’ as a reference to determine the spatial filter used to transmit the UL channel ‘Uc’ or RS ‘Ur’.

The term ‘higher layer’ in the following, when used in isolation, denotes any communication layer above the physical layer in the protocol stack.

The term serving cell and carrier component (CC) may be used interchangeably in this disclosure as a serving cell configured for a UE and is usually a separate physical carrier centered around a particular carrier frequency. Depending on the frequency of a component carrier/serving cell, the size of the cell and the beamformed reference signals may vary.

The phrase ‘fixed/predetermined/provided in the specifications’ in this invention disclosure may mean the following: one or more rules and/or methods and/or particulars regarding certain parameter(s) are provided in the standard specifications that the UE and/or any network node is supposed to follow or implement.

The term ‘configured’ may mean the following: one or more rules and/or methods and/or particulars regarding one or more parameters as provided in the standard specifications that the UE is supposed to follow or implement are provided to the UE by one or more network entities, e.g., via higher layer signaling, like radio resource control, RRC, signaling.

In the following, methods to manage multiple UL and/or DL beams in a cell are provided, which are especially useful in multi-TRP and/or multi-panel scenarios.

### SUMMARY

It is an object of embodiments herein to provide methods and apparatuses for a unified beam management framework with multiple beams, suitable for 5G.

According to an aspect of some embodiments herein, there is provided a method performed by a user equipment (UE), the method comprising: receiving from a network node, an indication of one or more transmission configuration indication (TCI) state(s) comprising one or more transmission and/or reception setting(s) for one or more uplink (UL) and/or downlink (DL) channel(s), channel resource(s) and/or reference signal(s), via one or more physical (PHY) layer or higher layer signaling. The method further comprises, receiving from the network node or performing an association of one or more UL and/or DL channel(s), channel resource(s) and/or reference signal(s) with value(s) of an index or parameter, wherein a UL or DL channel or channel resource or reference signal is associated with a value of said index or parameter, and—updating or applying at least one transmission and/or reception setting in a TCI-state for a group of one or more UL and/or DL channel(s), channel resource(s) and/or RS(s) that are associated with the same value of the index or parameter.

According to another aspect of some embodiments herein, there is provided a method performed by a UE, the method comprising: receiving from a network node, an indication of one or, TCI state(s) comprising one or more transmission and/or reception setting(s) for one or more UL and/or DL channel(s), channel resource(s) and/or reference signal(s), via one or more physical, PHY, layer or higher layer signaling. He method further comprises, receiving from the network node or performing an association of one or more UL and/or DL channel(s), channel resource(s) and/or reference signal(s), RS(s), with value(s) of two or more indices or parameters, wherein a UL or DL channel or channel resource or reference signal is associated with a value of an index or parameter, and updating or applying at least one transmission and/or reception setting in a TCI-state for a first group of one or more UL and/or DL channel(s), channel resource(s) and/or RS(s) associated with a first value of a first index and a second group of one or more UL and/or DL channel(s), channel resource(s) and/or RS(s) associated with a second value of a second index.

According to yet another aspect of some embodiments herein, there is provided a method performed by a UE, the method comprising: receiving from a network node M≥1 TCI-states, via a physical downlink control channel, PDCCH, or a higher layer signaling, and applying the M TCI-states to:
one or more transmission occasions, or one or more parts of a transmission occasion of one or more physical channels, according to a predetermined or indicated mapping of the TCI-states and said transmission occasion(s) or part(s) of said one transmission occasion, wherein said physical channel transmission(s) is/are scheduled by a PDCCH or higher layer signaling different from the PDCCH or higher layer signaling providing the TCI-state indication, and/or
one or more reference signal (RS) resources or resource sets according to a predetermined or indicated mapping of the TCI-states with said resources or resource sets.

According to yet another aspect of some embodiments herein, there is provided a method performed by a UE, the method comprising:
receiving from a network node an indication of M≥1 transmission configuration indication-states, TCI-states, via physical, PHY, layer and/or higher layer signaling, and
applying a default TCI state from said M TCI-states to port(s), resource(s), transmission and/or reception occasion(s) associated with one or more channel(s) and/or reference signal(s).

According to yet another aspect of some embodiments herein, there is provided a UE comprising a processor and a memory containing instructions executable by the processor, whereby said user equipment is configured to or operative to perform the method according to any one of method claims 1-59.

There is also provided a computer program comprising instructions which when executed by the processor of the UE cause the processor to carry out the method according to any one of claims 1-59.

According to an aspect of some embodiments herein, there is provided a method performed by a network node, the method comprising: transmitting to a UE an indication of one or more TCI state(s) comprising one or more transmission and/or reception setting(s) for one or more UL and/or DL channel(s), channel resource(s) and/or reference signal(s), via one or more PHY layer or higher layer signaling. The method further comprises, transmitting to the UE an association of one or more UL and/or DL channel(s), channel resource(s) and/or reference signal(s) with value(s) of an index or parameter, wherein a UL or DL channel or channel resource or reference signal is associated with a value of said index or parameter; for enabling the UE to update or apply at least one transmission and/or reception setting(s) in a TCI-state for a group of one or more UL and/or DL channel(s), channel resource(s) and/or RS(s) that are associated with the same value of the index or parameter.

According to another aspect of some embodiments herein, there is provided another method performed by the network node, the method comprising: transmitting to a UE an indication of one or more TCI state(s) comprising one or more transmission and/or reception setting(s) for one or more UL and/or DL channel(s), channel resource(s) and/or reference signal(s), via one or more PHY layer or higher layer signaling. The method further comprises, transmitting to the UE an association of one or more UL and/or DL channel(s), channel resource(s) and/or reference signal(s), RS(s), with value(s) of two or more indices or parameters, wherein a UL or DL channel or channel resource or reference signal is associated with a value of an index or parameter; for enabling the UE to update or apply at least one transmission and/or reception setting in a TCI-state for a first group of one or more UL and/or DL channel(s), channel resource(s) and/or RS(s) associated with a first value of a first index and a second group of one or more UL and/or DL channel(s), channel resource(s) and/or RS(s) associated with a second value of a second index.

According to yet another aspect of some embodiments herein, there is provided another method performed by the network node, the method comprising: transmitting to a UE M≥1 TCI-states, via a PDCCH, or a higher layer signaling, for enabling the UE to apply the M TCI-states to:
one or more transmission occasions, or one or more parts of a transmission occasion of one or more physical channels, according to a predetermined or indicated mapping of the TCI-states and said transmission occasion(s) or part(s) of said one transmission occasion, wherein said physical channel transmission(s) is/are scheduled by a PDCCH or higher layer signaling different from the PDCCH or higher layer signaling providing the TCI-state indication, and/or
one or more reference signal, RS, resources or resource sets according to a predetermined or indicated mapping of the TCI-states with said resources or resource sets.

According to yet another aspect of some embodiments herein, there is provided a method performed by a network node, the method comprising:
transmitting to a user equipment, UE, M≥1 transmission configuration indication-states, TCI-states, via physical, PHY, layer and/or higher layer signaling, and
for enabling the UE to apply a default TCI state from said M TCI-states to port(s), resource(s), transmission and/or reception occasion(s) associated with one or more channel(s) and/or reference signal(s).

According to another aspect of some embodiments herein, there is provided a network node comprising a processor and a memory containing instructions executable by the processor, whereby said network node is configured to or operative to perform the method according to any one of method claims 61-64.

There is also provided a computer program comprising instructions which when executed by the processor of the network node cause the processor to carry out the method according to any one of method claims 61-64.

A carrier is also provided containing the computer program(s) wherein the carrier is one of a computer readable storage medium, an electronic signal, or a radio signal.

Additional embodiments of the present invention will be presented in the detailed description.

An advantage with the embodiments of the present disclosure enables easier multilink network implementations and also achieves a reduction in control information overhead.

Additional advantages with the embodiments are presented in this detailed description.

### BRIEF DESCRIPTION OF DRAWINGS

FIG. 1 illustrates a flowchart of a method performed by a user equipment (UE) according to some embodiments herein

FIG. 2 illustrates a flowchart of another method performed by a UE according to some embodiments herein

FIG. 3A illustrates the TCI-state update for channels corresponding to different TRPs via PDCCHs associated with respective TRPs, according to some embodiments herein

FIG. 3B depicts the TCI-state update for channels corresponding to the same TRP via a PDCCH associated with a single TRP, according to some embodiments herein

FIG. 4 illustrates a flowchart of another method performed by a UE according to some embodiments herein

FIG. 5 illustrates a simplified block diagram of a UE according to some embodiments herein.

FIG. 6 illustrates a simplified block diagram of a network node according to some embodiments herein.

### DETAILED DESCRIPTION

In the following is presented a detailed description of the exemplary embodiments in conjunction with the drawings, in several scenarios, to enable easier understanding of the solution(s) described herein.

The physical downlink control channel (PDCCH) and the physical downlink shared channel (PDSCH) carry DL control information (DCI) and DL data, respectively, to a UE. The physical uplink control channel (PUSCH) carries both uplink control information (UCI) and UL data, while the physical uplink control channel (PUCCH) carries UL control information only.

### Physical Downlink Control Channel (PDCCH)

The PDCCH is configured at the radio resource control (RRC) layer level by a base station or a network node or a gNodeB (gNB). The gNB transmits the PDCCH(s) on one or more control resource sets (CORESETs) that are configured at RRC level. A CORESET is a configuration of resources associated with the physical downlink control channel. The downlink control information (DCI) is transmitted in the PDCCH on the resources associated with the CORESET. A CORESET comprises of N_{RB}^{CORESET} resource blocks (RBs) in the frequency domain (given by the higher layer parameter frequencyDomainResources) and N_{symb}^{CORESET} symbols in the time domain (given by the higher layer parameter duration). Each cell or carrier component may be configured with multiple bandwidth parts (BWPs) and each BWP may be configured with one or more CORESETs per bandwidth part per cell or carrier component. The configuration of CORESET(s) in a CC may be provided to the UE via a higher layer (for e.g., RRC).

Each CORESET comprises one or more control channel elements (CCEs). Each CCE comprises 6 resource element groups (REGs), where each REG equals one resource block in one orthogonal frequency division multiplexing (OFDM) symbol. Resource-element groups within a CORESET are numbered in increasing order in a time-first manner, starting with 0 for the first OFDM symbol and the lowest-numbered resource block in the control resource set. Each CORESET is associated with a CCE-to-REG mapping. The CCE-to-REG mapping for a CORESET can be interleaved or non-interleaved and is described by REG bundles. A REG bundle may comprise 2, 3 or 6 REGs.

A PDCCH carrying a DCI for one of the following purposes may be transmitted on one or more CCEs:
scheduling of the PDSCH or the PUSCH or NR/LTE sidelink channel, or
slot format indication, or
power control command transmission, or
cancelling of UL transmission, or
power saving information notification, or
soft resources availability notification, among others.

The number of CCEs used for a PDCCH is indicated by an ‘aggregation level’. If a PDCCH has an aggregation level of 4, the PDCCH is transmitted on 4 CCEs. A DCI of aggregation level L comprises L continuously numbered CCEs, and the CCEs are mapped on a number of REGs on a CORESET. The type of CCE-to-REG mapping used in a CORESET—interleaved or non-interleaved—and details regarding the mapping are provided in the corresponding CORESET configuration.

It should be noted that the terms PDCCH and DCI may be used interchangeably in this disclosure. Both terms refer to a downlink control channel information obtained via the physical layer.

The UE searches for valid PDCCH(s)/DCI(s) in the PDCCH candidates on configured search space sets on the CORESETs. A search space set that the UE searches for PDCCH candidates on a CORESET are provided via the higher layer configuration of the search space (SS) set—the information element SearchSpace. Each search space set is associated with a CORESET via higher layer configuration and comprises the number of PDCCH candidates in a given aggregation level where the UE performs blind decoding on in search of a valid PDCCH/DCI. The blind decoding process involves, in addition to error correction decoding, the unscrambling of the cyclic redundancy check (CRC) bits of each PDCCH candidate in every search space set with various radio network temporary identifier (RNTI) values that they can be possibly scrambled with and performing the CRC check to verify if the CCEs corresponding to the PDCCH candidate comprise a valid DCI according to the DCI formats to be monitored for the given search space set.

There are two types of SS sets:
Common search space (CSS) sets—commonly monitored by a group of UEs in the cell, and
UE-specific search space (USS) sets—monitored by an individual UE.

The categorization of the search space (SS) into one of the two types above is achieved by setting the parameter searchSpaceType in SearchSpace to ‘common’ or ‘ue-Specific’. Each search space set is associated with a CORESET—the ID of the associated CORESET is provided in contro/ResourceSet/d in the higher layer configuration SearchSpace. Each configured search space set is provided with a SearchSpaceld.

Apart from the CORESETs and the search space sets configured as indicated above, CORESET 0 and searchSpaceZero are separately provided to the UE. CORESET 0 is configured using the master information block (MIB), obtained from the cell-defining synchronization signal and physical broadcast channel (PBCH) block (SSB). CORESET 0 can be acquired even before higher-layer configurations are provided, i.e., before additional system information or dedicated configuration is provided, while its configuration is restricted to a limited number of combinations of parameters compared to other CORESETs. Similarly, search space 0, which is a common search space set, is also provided to the UE by the MIB and its configuration is restricted to a limited number of combinations of parameters compared to other search space sets.

The PDCCH(s) transmitted on common search space sets (CSSs) provide paging information, random access procedure information, system information block 1 (SIB1) and other system information to the UE among others. The higher layer configuration PDCCH-ConfigCommon provides the IDs of the search space sets used to obtain each of the aforementioned information. It also provides the list of common search spaces and optionally, the configuration of a common CORESET that can be used for any common or UE-specific search space, which is contained in the bandwidth of CORESET 0.

### Downlink Transmission Configuration Indication (DL-TCI)

Demodulation reference signals (DMRS) are embedded for the coherent demodulation of the PDCCH/PDSCH at the UE. The DMRS consists of a set of DMRS ports. The number of DMRS ports determines the number of transmission layers contained in a PDSCH. DMRS is used for channel estimation at the UE to coherently demodulate the PDSCH or PDCCH(s). In the case of PDCCH, one or more of them may be transmitted on a CORESET. Therefore, the DMRS for the coherent demodulation of the PDCCH(s) on the Control Resource Set (CORESET) may be embedded across the PDCCH(s) transmitted on the CORESET.

A parameter in the transmission of the PDCCH and the PDSCH is the ‘Transmission Configuration Indication’—state (TCI-state). The indication of how the control or the shared channel is transmitted by the gNB and what assumptions the UE must consider while receiving them, is done via reference signals (RSs). The indication to the UE is performed using a TCI-state information element (IE) configured via RRC. A TCI-state IE, among others, consists of the following elements:
One of more reference signal(s), and
for each reference signal, one or more quasi-colocation (QCL) assumptions.

The TCI-state is used to mention or indicate how to receive a PDSCH or the PDCCH(s) transmitted on a CORESET. Applying a TCI-state to a PDSCH or CORESET implies that the DMRS ports of the PDSCH or the DMRS ports of the PDCCH(s), transmitted on the CORESET, shall be assumed to be quasi-co-located with the reference signals mentioned or indicated in the TCI-state.

Assuming ‘quasi-colocation’ means that certain channel parameters such as Doppler shift/spread, delay spread, average delay and/or Tx beam direction are assumed to be the same for the RS mentioned in the TCI-state and the DMRS ports of the PDSCH, or the DMRS ports of the PDCCH(s) transmitted on the CORESET. Four different QCL types can be indicated:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

One or more of the QCL-Info parameter(s) is/are included in the TCI-state IE to provide the QCL assumption(s) associated with the TCI-state.

For example, a TCI-state IE comprising a DL reference signal (RS) ‘A’ with QCL assumption ‘QCL-typeA’ and a DL RS ‘B’ with QCL-assumption ‘QCL-TypeD’ is considered. Applying this TCI-state to a PDSCH or CORESET with the given quasi-colocation assumptions means that the UE may assume the same Doppler shift, Doppler spread, average delay and delay spread for the PDSCH or the PDCCH(s) transmitted on the CORESET and DL RS A, and the UE may use the same spatial filter to receive the DL RS ‘B’ and the PDSCH or the PDCCH(s) transmitted on the CORESET, or the Rx spatial filter to receive the PDCCH(s) on the CORESET or the PDSCH may be obtained from or be similar to that used for the reception of the DL RS ‘B’.

Usually, the TCI state that is used to schedule a PDCCH or a PDSCH contains the identifiers (IDs) of channel state information reference signals (CSI-RS) or synchronization signal blocks (SSB) along with the QCL assumptions for the reference signal. The RS in the TCI-state is usually a RS that the UE has measured before, so that it can use it as a reference to receive the DMRS of the PDCCH or PDSCH, and hence demodulate the same. The indication of a TCI-state for a CORESET or a PDSCH is performed via Medium Access Control-Control Element (MAC-CE) messages or using the TCI-indication field or the TCI field in the downlink control information (DCI) used to schedule the PDSCH. If a PDSCH is scheduled by a DCI without a TCI field, the TCI state of the PDSCH follows that of the CORESET on which the DCI that schedules the PDSCH was received.

In FR2, where the gNB and UE establish a connection via spatially selective/directive beams, the TCI-state is used to indicate the Rx beams in which the UE may receive, i.e., the spatial filter that may be used by the UE to receive a PDSCH/PDCCH(s) via a ‘qcl-TypeD’ assumption with a CSI-RS or an SSB that the UE has received. The determination of the DL Tx beam to transmit PDCCH(s)/PDSCH is performed via a beam sweeping procedure by the network node (e.g., the gNB). In a beam sweeping procedure, the gNB configures a set of DL RSs (CSI-RS or SSB) via RRC for the UE to measure the set of DL RSs. Each of the configured DL RS may be transmitted with a different spatial filter, i.e., each of the configured DL RS may be transmitted in a different direction by the gNB. The UE measures each of the configured DL RS by receiving them using one or more spatial filters—the RSs may all be received with the same spatial filter, or a different spatial filter may be used to receive each RS. Following the measurements, the UE sends a beam report to the gNB. The beam report comprises the indices of 1 L 4 configured DL RSs (essentially, L DL Tx beam directions, with each beam direction resulting from the use of a specific spatial filter at the gNB) along with the received power in each of the RSs. With the help of the beam report, the gNB determines one or more suitable DL Tx beam direction(s), i.e., spatial filter(s) for the transmission of the PDCCH(s) and the PDSCH.

### Physical Uplink Shared Channel (PUSCH)

The PUSCH transmission(s) from a UE can be dynamically scheduled by a network node via an UL grant indicated in the PDCCH or semi-persistently/statically scheduled with the higher layer configured grant configuredGrantConfig. The configured grant Type 1 PUSCH transmission is semi-statically configured to operate upon the reception of a higher layer parameter of configuredGrantConfig including rrc-ConfiguredUplinkGrantwithout the detection of an UL grant in the PDCCH. The configured grant Type 2 PUSCH transmission is semi-persistently scheduled by an UL grant in a valid activation PDCCH after the reception of the higher layer parameter configuredGrantConfig not including rrc-ConfiguredUplinkGrant.

The mode of transmission of the PUSCH is determined by the higher layer parameter ‘txConfig’. The parameter can be set to either ‘codebook’ or ‘nonCodebook’ or it may not be configured. When the PUSCH is scheduled via the PDCCH, two different downlink control information (DCI) formats may be used in the scheduling-PDCCH—DCI format 0_0 or DCI format 0_1. The codebook- and non-codebook-based PUSCH transmissions are scheduled using DCI format 0_1, when scheduled via the PDCCH. When scheduling the PUSCH using DCI format 0_1, the gNB indicates the ports from which the UE has to transmit via the SRS resource indicator (SRI). The SRI field in DCI format 0_1 indicates one or more SRS resource(s) from a codebook or non-codebook SRS resource set, which means that the UE must transmit the PUSCH via the SRS ports associated with the SRS resources indicated via the SRI.

In the case of codebook-based PUSCH, the UE determines its PUSCH transmission precoder based on the SRI, transmit precoding matrix index (TPMI) and the transmission rank, where the SRI, TPMI and the transmission rank are given by fields of the SRS resource indicator and precoding information and number of layers in the scheduling DCI, or by a higher layer configuration of the PUSCH grant. In the case of non-codebook-based PUSCH, the UE is not provided with any explicit indication of a precoding.

The beam direction or spatial relation of the PUSCH is determined from the beam direction/spatial relation of an SRS or a PUCCH resource depending on the mode of PUSCH transmission:
Codebook- or non-codebook-based PUSCH transmission is indicated with an SRS resource. The UE sounds the UL channel with SRS resources (which are configured specifically for the codebook/non-codebook transmission mode) and the gNB, in return, schedules the PUSCH via the indication of an SRS resource. The UE, thereby, transmits the PUSCH from the same ports from which the SRS resource was transmitted and uses the same beam direction/spatial relation for the transmission of the PUSCH as for the transmission of the SRS resource.
When the UE is scheduled by DCI format 00 (single-port PUSCH), the spatial relation used for the transmission of the PUSCH is the same as that used for the transmission of the PUCCH resource with the lowest ID in the currently active UL bandwidth part (BWP).

The pathloss reference RS, which is configured/indicated via a higher layer, is used in the power control settings of the PUSCH to determine the pathloss estimate for the transmission of the PUSCH. The pathloss reference RS for the PUSCH is determined in different ways for different modes of PUSCH transmission. The PUSCH is configured with a list of pathloss reference RSs in ‘PUSCH-PathlossReferenceRS’ IEs and in most cases, it uses the list to obtain the pathloss reference RS.
For codebook- or non-codebook-based PUSCH transmission scheduled by the PDCCH, the pathloss reference RS is configured in ‘SRI-PUSCH-PowerControl’ IEs. As previously presented, SRI stands for SRS Resource Indicator. These IEs contain the power control settings for the PUSCH such as the ID of a PUSCH-pathlossReferenceRS, ‘alpha’ values (pathloss compensation factor) and the closed loop power control index. The mapping between the PUSCH-pathlossReferenceRS IEs and the SRI-PUSCH-PowerControl IEs can be modified using Medium Access Control-Control Element (MAC-CE) messages. The SRS resource indicator (SRI) mentioned for the codebook/non-codebook PUSCH transmission maps to a ‘SRI-PUSCH-PowerControl’ IE that provides these power control settings. When there is no SRI field in the scheduling PDCCH, the UE uses the SRI-PUSCH-PowerControl whose ID value is set to 0.
For single-port PUSCH (scheduled by the PDCCH via DCI format 0_0), the pathloss reference RS is obtained from the same PUCCH resource that it obtains the spatial relation from.
When the PUSCH is scheduled by a higher layer grant, the pathloss reference RS to be used is indicated via a pathlossReferenceIndex that points to a PUSCH-pathlossReferenceRS IE or is obtained from the SRI-PUSCH-PowerControl whose ID value is set to 0 when there is no SRS resource indicator field.

The transmit power of PUSCH is thereby determined from a combination of open loop and closed loop power control parameters. If a UE transmits a PUSCH on active UL BWP b of carrier f of serving cell c using parameter set configuration with index j and PUSCH power control adjustment state with index 1, the UE determines the PUSCH transmission power in PUSCH transmission occasion i as:

$${P}_{PUSCH , b , f , c} ( i , j , {q}_{d} , l ) = min \{ \begin{matrix}{P}_{CMAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ]$$

where,
P_{CMAX, f,c} (i) is the configured maximum UE transmit power.
P_{O_PUSCH,b,f,c}(j) is a parameter composed of the sum of the nominal PUSCH transmission power P_{O_NOMINAL_PUSCH,f,c}(J) and P_{O_UE_PUSCH,b,f,c}(I) both of which are configured via a higher layer by the gNB.
M_{RB,b,f,c}^{PUSCH} (i) is the bandwidth of the PUSCH resource assignment expressed in number of resource blocks.
PL_{b,f,c}(q_{d}) is a downlink pathloss estimate in dB calculated by the UE using DL reference signal (RS) index q_{d}. The configuration/indication of the pathloss reference RS is as described above.
a_{b,f,c}(j) is a pathloss compensation factor configured via higher layer by the gNB.
f_{b,f,c}(i, l) is a closed loop power correction function that changes depending on the transmit power control (TPC) feedback from the network node or gNB.
Δ_{TF,b,f,c}(i) is a power offset value dependent on the modulation and coding scheme (MCS) used for the PUSCH.

In addition, default spatial relations and pathloss reference RS can be defined for UL channels/RSs. In scenarios where beamformed transmissions are used (common in frequency range 2), the pathloss reference and the spatial relation may be derived from a downlink channel. This means the DL RS used as a reference to obtain the beam direction for receiving a DL channel (e.g., indicated via the TCI state) at the UE may be used as a reference to derive the spatial relation for an UL channel or UL RS and used in the calculation of the pathloss estimate for the Tx power calculation of the UL transmission.

Defining default spatial relations and pathloss reference RSs helps the network to avoid explicit indication of the parameters, especially in FR2 deployments, thereby reducing control information overhead and latency. In the case of PUSCH, the default assumptions are obtained from a CORESET or from PUCCH resources configured on the CC (Component Carrier), depending on whether there are PUCCH resources configured on the CC or not.

### Sounding Reference Signal (SRS)

Sounding Reference Signals (SRSs) are used for sounding the UL channel. The basic unit of the SRS is an SRS resource. An SRS resource is a specific pattern of reference symbols in time, frequency and code transmitted by all or a subset of UE's antenna ports in the UL to sound the UL channel. The UE is configured by the network node or gNB via the RRC with one or more SRS resource sets, with each SRS resource set consisting of one or more SRS resources. Each SRS resource set is provided with identifiers—SRS resource set identifiers (IDs) or indices. The SRS resources in the SRS resource sets may also be provided with IDs or indices.

In the SRS resource set configuration, the parameter ‘usage’ indicates the purpose for which the SRS is used:
1) Usage=‘codebook’: to sound the UL channel before a codebook-based-PUSCH transmission.
2) Usage=‘non-codebook’: to sound the UL channel before a non-codebook-based-PUSCH transmission.
3) Usage=‘beamManagement’: to sound the UL channel with beamformed SRS resources to identify suitable UL beams.
4) Usage=‘antennaSwitching’: to sound the UL channel to obtain DL channel information.

The SRS-SpatialRelationInfo IE provides the beam direction that the UE should use for the SRS resource via a CSI-RS or an SSB or an SRS resource. With this signaling, the gNB indicates to the UE that it shall use the spatial filter used for the reception of the SSB or CSI-RS resource or the transmission of the SRS resource provided in the SRS-SpatialRelationInfo IE of an SRS resource to transmit the SRS resource. The indication of the SRS-SpatialRelationlnfo is vital in the case of FR2 where beamformed transmissions are required. The pathloss reference RS, which is configured via the RRC or indicated via a MAC, is used in the power control settings of the SRS to determine the PathLoss (PL) estimate for the transmission of the SRS.

The transmit power of SRS is obtained by a combination of parameters configured/indicated to the UE as follows: If a UE transmits SRS on active UL bandwidth part b of carrier f of serving cell c using SRS power control adjustment state with index 1, the UE determines the SRS transmission power P_{SRS,b,f,c}(i, qₛ, l) in SRS transmission occasion i for the SRS resource set qₛ as:

$${P}_{SRS , b , f , c} ( i , {q}_{s} , l ) = min \{ \begin{matrix}{P}_{CMAX , f , c} ( i ) , \\ {P}_{O\_SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \} [ dBm ]$$

where,
P_{CMAX, f,c}(i) is the configured maximum UE transmit power.
P_{O_SRS,b,f,c}(qₛ) is provided by the higher layer parameter p0 or the nominal PUSCH Tx power.
M_{SRSb,f,c}(i) is an SRS bandwidth expressed in number of resource blocks, which is obtained from the SRS configuration.
PL_{b,f,c}(g_{d}) is a downlink pathloss estimate in dB calculated from the DL RS q_{d} for the SRS resource set qₛ. The pathloss estimate may be derived from the pathloss reference RS (a CSI-RS or an SSB resource) configured/indicated via a higher layer.
α_{SRS,b,f,c}(qₛ) is a pathloss compensation factor configured by the higher layer parameter Alpha.
h_{b,f,c}(i, l) is a closed loop power correction function that is dependent on the closed loop power control adjustment state configured in the SRS resource set IE.

### Physical Uplink Control Channel (PUCCH)

The physical uplink control channel (PUCCH) carries control information such as channel state information (CSI) feedback, the hybrid automatic repeat request (HARQ) acknowledgement (ACK)/negative acknowledgements (NACK) for physical downlink shared channel (PDSCH) transmissions, and scheduling requests (SR). A unit of the PUCCH that carries uplink control information (UCI) is a PUCCH resource. A PUCCH resource is an RRC configured space in a certain format (format 0, 1, 2, 3) in a certain UL bandwidth-part (BWP). The UL-BWP is a contiguous frequency domain space on which the UE transmits in the UL. The UE may be configured with up to 4 UL-BWPs, and it transmits on only one of them at a given time instance. The UL BWP on which the UE transmits is the active UL BWP.

Two types of PUCCH resources exist—common PUCCH resources and UE-dedicated PUCCH resources. In the case of UE-dedicated PUCCH resources, the UE is configured with four PUCCH resource sets via RRC. The PUCCH resources in a given PUCCH resource set can carry a specified load of uplink control channel information as indicated by the higher-layer parameter ‘maxPayloadMinus1’. The other parameters in the PUCCH resource configuration indicate the frequency hopping characteristics of the PUCCH resource.

The PUCCH resources that may carry the various types of the uplink control information (UCI)
Hybrid automatic repeat request (HARQ) acknowledgement (ACK)/negative acknowledgements (NACK) for physical downlink shared channel (PDSCH) transmissions, scheduling requests (SR) and DL channel state information (CSI) feedback—are configured and indicated as follows:
   The PUCCH resource that carries the HARQ ACK/NACK for a PDSCH, is indicated by a 3-bit PUCCH resource indicator field in the PDCCH that schedules the PDSCH. The mapping from the PUCCH resource indicator field contained in the PDCCH to a PUCCH resource in the four PUCCH resource sets is configured by the gNB via RRC.
   The scheduling requests (SR) are configured via RRC in the ‘SchedulingRequestConfig’ IE and other associated IEs, and each scheduling request configuration includes the IDs of PUCCH resource(s) that carry the SRs. The transmission settings of the SRs (periodicity, offset, etc.) are configured at the RRC level.
   The CSI report configurations received via RRC at the UE includes the IDs of the PUCCH resources(s) that carry the semi-persistent and/or periodic CSI reports in the UL. The transmission settings of the same are provided in the CSI report configurations. The activation/deactivation of the semi-persistent CSI reports is handled via MAC-CE messages. The configuration of the CSI reports via RRC is enough for the transmission of periodic CSI reports.

The beam direction and power control settings of the PUCCH resources are configured together in a ‘PUCCH-SpatialRelationInfo’ IE. The parameter ‘referenceSignal’ in the PUCCH-SpatialRelationInfo IE contains the ID of a DL reference signal (a CSI-RS, or an SSB), or a UL reference signal (sounding reference signal—SRS). The other parameters in the PUCCH-SpatialRelationInfo IE comprise open and closed loop power control settings for the PUCCH transmission.

Applying a ‘PUCCH-SpatialRelationInfo’ IE to a PUCCH resource means that the UE shall use the same spatial filter as it uses for the reception of the DL RS or the transmission of the UL RS mentioned in the parameter ‘referenceSignal’ of the IE for the transmission of the PUCCH resource, and should apply the power control parameters in the IE to derive the transmit power for the transmission of the PUCCH resource. The PUCCH resources may be grouped via a higher layer configuration (e.g., RRC). Each grouping of PUCCH resources may be provided with a PUCCH resource group ID for the application of spatial relation to a group of one or more PUCCH resources.

The derivation of the transmit power of a PUCCH resource comprises the addition of open loop and closed loop power adjustments. If a UE transmits a PUCCH on an active UL bandwidth-part (BWP) b and carrier f in the primary cell c using a PUCCH power control adjustment state with index 1, the UE determines the PUCCH transmission power P_{PUCCH,b,f,c}(i,qᵤ,q_{d},l) in PUCCH transmission occasion i as:

$${P}_{PUCCH , b , f , c} ( i , {q}_{u} , {q}_{d} , l ) = min \{ \begin{matrix}{P}_{CMAX , f , c} ( i ) , \\ {P}_{O\_PUCCH , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + {Δ}_{F\_PUCCH} ( F ) + {Δ}_{TF , b , f , c} ( i ) + {g}_{b , f , c} ( i , l )\end{matrix} \} [ dBm ]$$

where,
P_{CMAX, f,c}(i) is the configured maximum UE transmit power,
P_{O_PUCCH,b,f,c}(qᵤ) Is the sum of the nominal PUCCH transmit power P_{O_NOMINAL_PUCCH}, provided by a higher layer parameter p0-nominal (or set to a default value of 0 dBm), and P_{O_UE_PUCCH}(qᵤ) provided by the parameter p0-PUCCH-Value and other dependent parameters. The ID of the p0-PUCCH-Value to choose is provided in p0-PUCCH-Id in the PUCCH-SpatialRelationInfo IE. The value qᵤ is the size of for a set of P_{O_UE_PUCCH} values provided via the higher layer parameter maxNrofPUCCH-P0-PerSet.
M_{RB,b,f,c}^{PUCCH} (i) is the bandwidth of the PUCCH resource, which is obtained from the configuration of the PUCCH resource.
PL_{b,f,c}(q_{d}) is a downlink pathloss estimate in dB calculated using RS resource index q_{d}. The UE may be indicated explicitly with a pathloss reference RS for PUCCH via a PUCCH-SpatialRelationInfo. The pathloss reference RS is essentially a DL RS from which the UE estimates the pathloss from the gNB or any other network entity.
The parameters Δ_{F_PUCCH}(F) and Δ_{TF,b,f,c}(i) are PUCCH power adjustment factors dependent on the PUCCH format.
The parameter g_{b,f,c}(i, l) is a closed loop power adjustment dependent on a PUCCH power control adjustment state (configured in the parameter closedLoopIndex in the PUCCH-SpatialRelationInfo IE).

The UE is configured with up to 8 PUCCH-SpatialRelationInfo parameters and with up to 64 PUCCH-SpatialRelationInfo IEs. A specific beam direction and power control setting is applied to a PUCCH resource or a PUCCH resource group via a MAC-CE message that associates a PUCCH resource or a group of PUCCH resources with a PUCCH-SpatialRelationInfo.

### Multi-TRP Scenarios

Multi-TRP transmissions that improve the reliability and robustness of were standardized. A network node (or gNB) may be viewed as a TRP. Two types of multi-TRP transmissions are possible:
Single DCI based multi-TRP: A single DCI schedules transmission of PDSCH(s) from more than one TRP—the PDSCH(s) may be multiplexed in space, time and/or frequency domains. When the PDSCH(s) are multiplexed to the UE in space, time and/or frequency domains from different TRPs, the TCI-field in the DCI may indicate more than one TCI-state to indicate the QCL assumptions for the reception of multiple parts of a single PDSCH or multiple PDSCHs. The TCI-field in the PDSCH-scheduling DCI, which supports only single-TRP transmissions from a single DCI, indicates only one TCI-state for the scheduling of a PDSCH. The TCI-field is of size b bits and can indicate up to2^{b} different TCI-states. A higher layer, however, may configure T≥2^{b} TCI-states. For the purpose of indication via the TCI-field for the PDSCH, the UE may receive a MAC-CE message that down-selects 2^{b} TCI-states from the T TCI-states configured via a higher layer so that each codepoint of the TCI-field maps to a TCI-state. To support single-DCI based multi-TRP transmissions, a MAC-CE message providing a mapping of one or more higher-layer-configured TCI-states with a codepoint of the TCI-field to the UE, is used.
Multi-DCI based multi-TRP: In this scenario, at a given time instant, the UE may receive multiple PDSCHs, each scheduled by a different DCI. The CORESETpoolIndex is a parameter provided in the configuration of a CORESET or associated with a CORESET. It is useful in such a scenario. This parameter or index may be used to group CORESETs into different pools. The pools may be organized according to the TRPs they are associated with in the case of multi-TRP transmissions. The PDCCHs transmitted on the CORESETs configured with the same CORESETpoolIndex value may be considered to be associated with the same TRP. A CORESET belonging or associated to a CORESETpoolIndex means that the higher layer configuration of the CORESET may comprise said CORESETpoolIndex (value). When a UE is configured, by the network node, with multiple CORESETpoolIndex values, the UE understands that it may receive multiple PDSCHs, possibly overlapped in time and frequency domains, scheduled by multiple PDCCHs that are received on CORESETs configured with different CORESETpoolIndex values, i.e., CORESETs associated with different TRPs.

### Unified TCI Framework

The unified TCI framework is an upgrade for DL/UL settings indication/configuration and/or beam management framework that combines indication of multiple channels and/or RSs.
The UE is provided with one or more pool of TCI-states—a given pool of TCI-states may be for both DL and UL, or for either one of DL or UL.
A signaling via MAC-CE/DCI, which may be called the common TCI-update signaling, may be used to simultaneously update the DL reception and/or UL transmission setting(s) for at least one of the following sets of channel(s) and/or reference signal(s) using the pool(s) or TCI-states configured:
   At least UE-dedicated PDCCH, related PDSCH and PUSCH, at least a subset of UE dedicated PUCCH, and optionally at least one of the following: CSI-RS resource(s), SSB resource(s), SRS resource(s)
   At least UE-dedicated PDCCH, related PDSCH, and optionally at least one of the following: CSI-RS resource(s), SSB resource(s)
   At least UE-dedicated PUCCH, UE-dedicated PUSCH, and optionally at least one of the following: SRS resource(s)
For signal(s) and/or channel(s) that are not updated using the common TCI-update signaling, legacy mechanisms may be reused, wherein the DL transmission setting(s) and/or the UL transmission setting(s) for the respective signal(s) or channel(s) is provided via the TCI pool(s) configured above, i.e., the transmission and/or reception setting(s) for the DL/UL channel(s) and signal(s) which were provided using legacy TCI-states/spatial relation or other related configuration or signaling, would be provided with such settings instead with the novel TCI-states/TCI pool(s) for a unified TCI framework.
The TCI-states may be configured or associated with at least one of the following setting(s): quasi-colocation settings to be used during a DL reception, pathloss reference RS(s), power control settings. The configuration or association may be performed via RRC, MAC-CE or any other means provided or possible via the NR specifications. Depending on the configured parameters, a TCI-state may be a DL TCI-state, a UL TCI-state or a joint DL/UL TCI-state.

In the next section, we proceed to address the extension of the unified TCI framework to multi-TRP transmissions.

Segregation of Channels with One or More Indices

The unified TCI framework is applicable for transmissions where a UE is communicating with a single TRP or uses a single antenna panel. In the following, an extension of the TCI framework for multi-TRP or multi-panel scenarios is proposed. In this invention, it is proposed that the transmission and reception settings for various channel(s) and/or RSs are shared via configured or associated indices. Deriving or sharing Tx/Rx settings between channels and/or RSs with the indices or via a mapping between values of different indices is also possible, which reduces the signaling overhead of the network.

The transmit/transmission/Tx settings mentioned in this invention disclosure denotes one or more of the following parameters associated with a transmission:
a spatial filter/spatial relation/beam direction setting,
a spatial relation/transmission (Tx) spatial filter/Tx beam direction,
a pathloss reference RS or pathloss reference resource,
the port(s) to be used for the transmission,
closed loop power control indication, parameters such as alpha and p0 that are used in the computation of the power to be used in a transmission (for e.g., UL transmission).

The spatial relation/Transmitted (Tx) spatial filter/Tx beam direction, pathloss reference RS or pathloss reference resource for an UL transmission may be provided with reference to a one or more reference signals or channel resources. In this disclosure, channel resources denotes higher layer configured resources associated with a physical layer channel. For example, CORESETs are resources of the physical downlink control channel and PUCCH resources are resources of the physical uplink control channel.

A receive/reception/Rx setting in this invention disclosure may be a quasi-colocation setting that indicates the derivation of at least one of the following parameters with reference to one or more reference signals for a UE reception: Doppler shift, Doppler spread, average delay, delay spread and/or Receiver (Rx) spatial filter/Rx beam direction.

The explicit indication of the Tx setting(s) for UL transmission(s) and/or Rx setting(s) for DL reception(s) at the UE are provided via transmission configuration indication, TCI, state(s) or configuration(s) from a network node.

A TCI-state or a TCI configuration may apply only to one or more UL transmissions, only to one or more DL transmissions, or apply jointly to one or more UL and DL transmissions. A TCI-state that applies only to UL transmission(s) may be called an UL TCI state. An UL TCI-state may provide only Tx setting(s) for UL transmission(s). A TCI-state that applies only to DL transmission(s) may be called a DL TCI state. A DL TCI-state may provide only Rx setting(s) for DLtransmission(s). A TCI-state that applies to both DL and UL transmissions may be called a joint TCI state. A joint TCI-state may comprise both Tx and Rx setting(s).

In this invention disclosure, the update or application with a TCI-state for/to a DL channel or RS at the UE, or the update or application with a TCI-state for/to the reception of a DL channel or RS at the UE means that at least one reception setting provided in said TCI-state is applied or used by the UE for the reception of said DL channel or RS (the transmission of said channel or RS may be made by a network node). The TCI-state applied or updated for/to a DL channel or RS may be a DL TCI-state or a joint TCI-state. Similarly, the update or application with a TCI-state for/to an UL channel or RS, or the update or application with a TCI-state for/to the transmission of an UL channel or RS means that at least one transmission setting provided in said TCI-state is applied or used by the UE for the transmission of said UL channel or RS (the transmission may be received by a network node or another UE). The TCI-state updated or applied for/to a UL channel or RS may be a UL TCI-state or a joint TCI-state. The term ‘TCI-state update’ or ‘TCI-update,’ in general, for a DL or UL channel or reference signal implies that one or more transmission or reception setting(s) of said DL or UL channel or RS are updated using the setting(s) provided in the TCI-state. There may be different types of TCI-states.

In certain embodiments herein, the UE is configured to receive an association or to perform an association of one or more UL and/or DL channel(s), channel resource(s) and/or reference signal(s) with a value of an index or a parameter, wherein one or more channel(s), channel resource(s) and/or reference signal(s) associated with the same value of said index or parameter is/are applied or updated with the same transmission and or reception setting(s).

In some examples, transmission and/or reception setting(s) mentioned above may be provided by one or more transmission configuration indication (TCI) state(s) or TCI configuration(s). The TCI-states are configured via a higher layer (e.g., RRC). They may be indicated for said one or more UL and/or DL channel(s) and/or reference signal(s) via a higher layer (e.g., RRC).

According to some embodiments, a method performed by a UE, the method comprising, receiving from the network node or performing an association of one or more UL and/or DL channel(s), channel resource(s) and/or reference signal(s) (RS(s)) with value(s) of one or more indices or parameters, wherein a UL or DL channel or channel resource or reference signal is associated with a value of an index or parameter.

The aforementioned index/indices is/are used to group channel(s), channel resource(s) and/or RS(s) into various methods of groupings. With the use of one of these groupings or a plurality of these groupings, the TCI-state(s) may be indicated and/or transmission and/or reception setting(s) may be updated for various channel(s), channel resource(s) and/or RS(s). The values used for the index/indices/parameters may be non-negative, integer numbers. Two different uses of said index/indices may be possible. Using just one index, within one use-case, the beam or Tx/Rx settings indication may be segregated. With the use of multiple indices, across different use-cases, the Tx/Rx settings may be segregated and mapped.

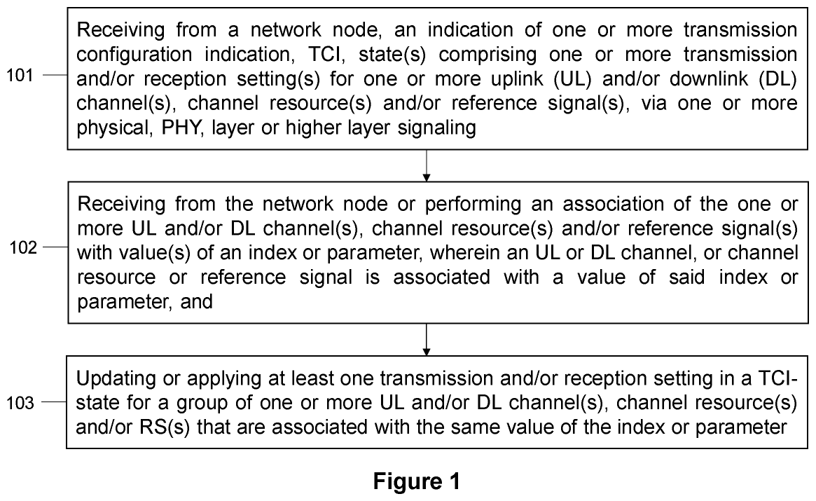

According to some embodiments, a method performed by a UE is provided as illustrated in FIG. 1. As shown the method comprises:
receiving (101) from a network node, an indication of one or more TCI state(s) comprising one or more transmission and/or reception setting(s) for one or more UL and/or DL channel(s), channel resource(s) and/or reference signal(s), RS(s), via one or more physical, PHY, layer or higher layer signaling,
receiving from the network node or performing (102), an association of one or more UL and/or DL channel(s), channel resource(s) and/or RS(s) with value(s) of an index or parameter, wherein an UL or DL channel or channel resource or RS is associated with a value of said index or parameter, and
updating or applying (103) at least one transmission and/or reception setting in a TCI-state for a group of one or more UL and/or DL channel(s), channel resource(s) and/or RS(s) that are associated with the same value of the index or parameter.

The updating or applying of transmission (Tx) or reception (Rx) setting in a TCI-state for a channel, channel resource or RS, may mean that during the transmission or reception of said channel, channel resource or RS, the setting with which the said channel, channel resource or RS is transmitted or received is obtained or derived from the Tx/Rx setting provided in the TCI-state. In some examples, a Tx/Rx setting provided in a TCI-state for a certain purpose is used for said purpose by the UE for said channel, channel resource or RS. For instance, if a TCI-state comprises a DL RS for deriving/calculating a Doppler shift for a DL reception, the UE may use said DL RS to derive/calculate a Doppler shift for one or more DL receptions of a said DL channel, channel resource or RS. In some other examples, an obtained/derived setting during the transmission of a channel, channel resource or RS may also be different from the provided (or indicated) Tx/Rx setting in the TCI-state. For instance, a TCI-state may provide a DL RS for obtaining an Rx spatial filter for the reception of a DL channel/RS. The UE may use said DL RS in the given Rx setting in the TCI-state to determine a Tx filter (spatial relation) for the transmission a said UL channel, channel resource or RS.

In the above method, the values of one index are used for the grouping of channels, channel resources and/or RSs configured. Channels/resources/RSs associated with the same value of the index can be considered to be originating or terminating at the same TRP, panel, etc and they may be provided with settings in one TCI-state. Such an association with an index allows efficiently separating channels and/or signals for multi-TRP/UE-panel transmissions and reduces the signaling overhead for the configuration/indication of the transmission setting(s) or reception setting(s) from a network node to the UE. When TCI-state(s) signalling is provided with one or more TCI-states, an indicated TCI-state may be applied to a group of channels, channel resources and/or RSs that have been grouped together using the same value of said index—for example, PDSCH, a subset of CORESETs, PUSCH, PUCCH resources and optionally, CSI-RS/SRS(s) may be provided with the same value of the index thereby grouping them together for TCI-state indication. The index may be a CORESET pool index, a PUCCH resource group index or a SRS resource set identifier (ID) or index. Or, an index may be introduced for the update of TCI-states, TCI-update-Index. The type of index used for the grouping of the channels may determine the use-case according to which the TCI-state application or update is performed. If a CORESET pool index is used, the TCI-state update may be performed via grouping in a multi-TRP scenario. The use of the SRS resource set index or PUCCH resource group index may mean the grouping of RSs/channels from the UE's perspective (for e.g., according to UE Tx/Rx panel configuration). There may be UL or DL specific grouping indices associated with specific UL or DL channels/RSs thereby allowing only UL TCI-state or DL TCI-state update respectively via a common TCI-state signalling such as the one described above. The use of the TCI-update-Index may be used across use-cases flexibly for TCI-state updates. In some examples, the TCI-update-Index is a higher layer parameter.

In the method below, use of multiple indices is described to connect different use-cases via grouping indices for efficient TCI-state update.

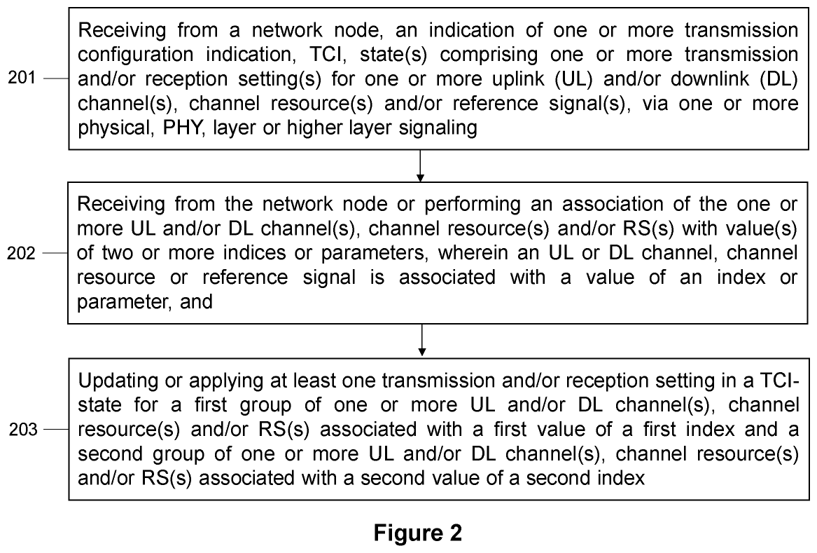

According to some embodiments, a method performed by a UE, as illustrated in FIG. 2. As shown the method comprising:
receiving (201) from a network node, an indication of one or more transmission configuration indication, TCI, state(s) comprising one or more transmission and/or reception setting(s) for one or more uplink (UL) and/or downlink (DL) channel(s), channel resource(s) and/or reference signal(s), via one or more physical, PHY, layer or higher layer signaling,
receiving from the network node or performing (202), an association of one or more UL and/or DL channel(s), channel resource(s) and/or RS(s), with value(s) of two or more indices or parameters, wherein an UL or DL channel, channel resource or reference signal is associated with a value of an index or parameter, and
updating or applying (203) at least one transmission and/or reception setting in a TCI-state for a first group of one or more UL and/or DL channel(s), channel resource(s) and/or RS(s) associated with a first value of a first index and a second group of one or more UL and/or DL channel(s), channel resource(s) and/or RS(s) associated with a second value of a second index.

In some examples, two indices may be present wherein the first index may be a TCI-update-Index and the second index or parameter mentioned above may be a ‘CORESETpoolIndex’ or a ‘PUCCH resource group index’. In some other examples, two indices may be present wherein, the first index may be a ‘CORESETpoolIndex’ or a ‘PUCCH resource group index’ and the second index may be a TCI-update-Index. In certain examples, two indices may be present wherein, one of the indices is an SRS resource set identifier (ID) or index.

It is to be noted that, a group of one or more UL and/or DL channel(s), channel resource(s) and/or RS(s) may comprise one UL or DL channel, channel resource or RS, or more than one UL and/or DL channel(s), channel resource(s) and/or RS(s).

The connection between the different indices helps to connect various methods of grouping—grouping with respect to TRP, grouping with respect to UE panels, grouping with respect to power control parameters, etc. A grouping of channels/RSs based on UE panels and a grouping of channel/RSs based on TRPs may be provided with Tx and/or Rx settings from a single TCI-state. With such a connection, different use-cases may be connected—a multi-panel UE may be integrated with a multi-TRP communication deployment, a power-control-based grouping at the UE may be exploited in a multi-TRP communication environment, etc.—thereby multiplying the number of possibilities of user and network co-existence. In an example, a TRP based grouping may be connected to a UE-panel-based grouping, i.e., the settings for channel(s) and/or RS(s) associated with a specific panel at the UE and the settings for channel(s) and/or RS(s) associated with the TRP that has the best link quality with said UE panel may be provided together or updated in connection with each other. Such co-existence of different use-cases and update of Tx/Rx settings with very little overhead are facilitated by this method.

In an example of the above method, the UE updates or applies the transmission and/or reception setting(s) in a TCI-state for a first group of one or more UL and/or DL channel(s), channel resource(s) and/or RS(s) associated with a first value of a first index and a second group of one or more UL and/or DL channel(s), channel resource(s) and/or RS(s) associated with a second value of a second index that is identical to said first value.

The following is to be noted for any method in this disclosure that comprises an indication of TCI-state(s) for one or more UL and/or DL channel(s), channel resource(s) and/or RS(s). If the indicated TCI-state(s) are UL TCI-states, it may apply to the UL channel(s), channel resource(s) and/or RS(s). Similarly, if the indicated TCI-states are DL TCI-states, it may apply to said DL channel(s), channel resource(s) and/or RS(s). In the case that joint TCI-states are indicated, it may apply to a combination of said UL and DL channel(s), channel resource(s) and/or RS(s). If the indicated TCI-states comprise a mixture of DL TCI-states and UL TCI-states, then the UL TCI-states may be applied to said UL channel(s), channel resource(s) and/or RS(s) and the DL TCI-states to said DL channel(s), channel resource(s) and/or RS(s).

According to an embodiment, the association of a channel and/or reference signal with a value of an index is performed/received in one of the following ways:
an explicit signaling via physical layer and/or higher layer signaling from the network node,
via the value of an index associated with the physical downlink control channel, PDCCH, that schedules or indicates or triggers the transmission of said channel or reference signal,
via the value of an index associated with another channel scheduled in the same carrier component (CC).

According to an embodiment, the scheduling PDCCH is used to obtain the value of an index for a given channel, channel resource or RS. If the scheduling PDCCH is associated with the same index as the channel, channel resource or RS, the value of the index of the scheduling PDCCH is also used for said channel, channel resource or RS. If a PDCCH is associated with a first index and a channel, channel resource or RS scheduled or indicated by it is associated with a second index, then one of the following may apply:
the value of the first index associated with the scheduling PDCCH may be assigned/assumed/associated for the second index used for said channel, channel resource or RS, or
a mapping of the value of the first index associated with the scheduling PDCCH to a value of the second index is performed and the mapped value is assigned/assumed/associated for the second index for said channel, channel resource or RS.

An example of performing or obtaining an association of a channel/channel resource/RS via the value of an index associated with another channel scheduled in the same carrier component is the association of a PUCCH resource and a PDSCH. If a PDSCH is associated with a certain value of the TCI-update-Index, the PUCCH resource that carries the HARQ ACK/NACK for the PDSCH may also be associated with the same value of the TCI-update-Index.

According to an embodiment, the UE is configured to perform an association of the one or more UL and/or DL channel(s), channel resource(s) and/or RS(s) with a default value of the index or parameter. This could happen, when the UE does not receive an indication of an association, for example, from a network node, of said UL and/or DL channels, channel resource(s) and/or RS(s) with a value of an index. The default value to be associated may be predetermined or fixed in the specifications (known to the UE). The default value to be associated with a channel, channel resource or RS may be determined/fixed based on other channels, channel resource(s) or RS(s) or parameters of said channel, channel resource or RS.

In general, a mapping of a value ‘a1’ of a first index to a LPF2 start value ‘b1’ of a second index in a certain method may mean the specification of a rule for said method wherein one or more first channel(s), channel resource(s) and/or RS(s) in the method(s) is/are associated with said first value ‘a1’ of said first index and one or more second channel(s), channel resource(s) and/or RS(s) in the method(s) is/are associated with said second value ‘b1’ of said second index. The ‘mapped value’ in a second index for a given value ‘a1’ of a first index in a method may mean the specification of a rule for said method wherein a fixed or predetermined value ‘b1’ of said second index is associated with given first index value ‘a1’. A mapping between two different indices or values from two different indices to derive/obtain a Tx/Rx settings for a channel and/or RS may mean the specification of a rule as follows: if a first channel or RS is associated with a first value of a first index, it may derive/obtain its Tx/Rx setting(s) from a second channel or RS that is associated with a second value of a second index. The first condition may be accompanied by other conditions as well (for e.g., a higher layer configuration to enable this behavior).

It is to be noted that, if a UE or a network node is to derive a setting for a target channel, channel resource or RS from that of a source channel, channel resource or RS, the source and target may not be provided with the same type (transmit or receive) of setting. A transmit setting for an UL transmission need not be derived only from another transmit setting. The transmit setting(s) for a channel/RS may be derived from the receive setting(s) of a different channel/RS, and vice versa. For example, the Rx-setting for a DL channel may be derived from a Tx-setting of an UL channel, and a Tx-setting for an UL channel may be derived from an Rx-settings of a DL channel. This is possible due to the use of reference signals for the indication of different settings. For example, a reference signal used in a QCL setting for a DL channel may be used as a pathloss reference RS for an UL transmission. Similarly, a RS used to derive a spatial relation/beam direction in the UL may be used to derive one or more parameters during a DL reception.

The one or more TCI state(s) or configuration(s) comprising one or more transmission and/or reception setting(s) for one or more uplink, and/or downlink channel(s) and/or reference signal(s) mentioned above may be indicated by one or more PDCCH(s), MAC-CE messages and/or higher layer signaling.

In some examples, the TCI-state(s) may be indicated in one or more PDCCH(s) via TCI indication field(s) in them. In some other examples, the TCI-state(s) may be indicated in one or more MAC-CE messages. In another example, the TCI-state(s) may be provided via a RRC signaling.

According to an embodiment, the UE is configured to receive an association or to perform an association of one or more UL and/or DL channel(s) and/or reference signal(s) with a value of an index or a parameter, wherein a group comprising one or more of the following associated with the same value of an index is updated with the same transmission and/or reception setting(s)
one or more PDSCH transmission occasions or PDSCH configurations
one or more PUSCH transmission occasions or PUSCH configurations
one or more channel resource(s) such as CORESET(s) and/or PUCCH resource(s)
one or more resource(s) or resource set(s) of reference signals, such as SRS, CSI-RS.

According to an embodiment, the TCI state(s) are indicated or comprised in one or more physical downlink control channel(s), PDCCH(s), wherein a CORESET on which one of the said PDCCH(s) is transmitted, is associated with a value of an index or parameter. This means that a PDCCH/DCI providing an indication of one or more TCI-state(s) is associated with the value of the index associated with the CORESET on which the PDCCH/DCI is transmitted.

According to an embodiment, one or more TCI state(s) are indicated or comprised in a MAC-CE message or a higher layer signaling that is associated with a value of an index or parameter. In an example, the value of said index or parameter is provided in said MAC-CE message or higher layer signaling.

According to an embodiment, the value/values of the index/indices associated with the PDCCH providing the TCI-state(s) and the one or more channel(s), channel resource(s) and/or reference signal(s), the TCI-states are applied to, is/are identical.

In certain embodiments, the UE is configured to receive an association or to perform an association of one or more UL and/or DL channel(s), channel resource(s) and/or reference signal(s) with a value of an index or a parameter, wherein a channel that is associated with value ‘x’ (for e.g., an non-negative, integer value) of the index or parameter provides the TCI-state signaling for the update of the Tx and/or Rx settings of one or more channel(s), channel resource(s) and/or reference signal(s) associated with a value ‘x’ of said index. For example, one or more channel(s), channel resource(s) or reference signal(s) associated with a value of ‘x’ of said index or parameter is/are applied or updated with the TCI-state(s) indicated by a PDCCH associated with value ‘x’ of said index or parameter.

In certain embodiments, the method performed by the UE comprises:
receiving from a network node or performing an association of one or more UL and/or DL channel(s), channel resource(s) and/or reference signal(s) with a value of a first index,
receiving from a network node or performing an association of one or more UL and/or DL channel(s), channel resource(s) and/or reference signal(s) with a value of a second index, and
deriving or obtaining the transmission or reception setting(s) of the channel(s), channel resource(s) or reference signal(s) associated with the first index from the transmission or reception setting(s) associated with the channel(s) or reference signal(s) associated with the second index via a mapping between the value(s) of the first index and second index.

According to an embodiment, the first or second index is a ‘CORESETpoolIndex’, a ‘Sounding Reference Signal, SRS, resource set ID/index’ or a ‘physical uplink control channel, PUCCH, resource group ID’.

In certain embodiments, the UE is configured to
receive from a network node or perform an association of one or more UL and/or DL channel(s), channel resource(s) and/or reference signal(s) with a value of a first index or a first parameter and
receive from a network node or perform an association of one or more UL and/or DL channel(s), channel resource(s) and/or reference signal(s) with a value of a second index or a second parameter, wherein
the transmission setting(s) or reception setting(s) of a channel, channel resource or reference signal associated with a first index or first parameter is derived/obtained from the transmission setting(s) or reception setting(s) or a TCI-state associated with a channel, channel resource or reference signal that is associated with a second value of a second index or second parameter or the TCI-state signaling obtained from a channel that is associated with a second value of a second index or second parameter.

The second value of the second index corresponding to a first value of the first index may be fixed in the specifications (known to the UE).

Association of an Index with Specific Channels

In the following, several embodiments that explicitly associate a channel or RS with an index are provided. The methods are described via the TCI-update-Index. As explained further below, they may be applicable with other indices as well (for e.g., CORESET pool index, SRS resource set ID/index, PUCCH resource group index, etc.).

In certain embodiments, the UE is configured to receive a physical downlink shared channel (PDSCH), wherein the associated PDSCH configuration, or the reception occasion of the PDSCH, is associated with a value of the TCI-update-Index. Similarly, in certain embodiments, the UE is configured to transmit a physical uplink shared channel (PUSCH), wherein an associated PUSCH configuration, or the transmission occasion of a PUSCH, is associated with a value of the TCI-update-Index. The association or linkage of the PDSCH or transmission occasion of the PDSCH, or the PUSCH or reception occasion of the PUSCH, is based on a higher layer configuration or indication (e.g., RRC, MAC-CE message), or the PDCCH scheduling said PDSCH/PUSCH.

In some examples, a higher layer configuration related to a downlink shared channel (for e.g., the RRC configuration PDSCH-Config) or an uplink shared channel (the RRC configurations PUSCH-Config, ConfiguredGrantConfig, or UCI-on-PUSCH which provide configurations of various types and/or parameters of PUSCH transmissions) may be provided with a value of TCI-update-Index. In some other examples, the association or linkage may be provided via a MAC-CE message.

In some examples, the UE is configured to receive a first configuration related to a PDSCH or PUSCH that is associated with a first value of TCI-update-Index, and a second configuration related to a PDSCH or PUSCH that is associated with a second value of TCI-update-Index.

In certain embodiments, the UE is configured to receive a physical downlink control channel transmission, wherein the associated PDCCH configuration or the associated CORESET, is associated with a value of the TCI-update-Index. The association or linkage is based on a higher layer configuration or indication (for e.g., the TCI-update-Index may be provided in the higher layer configuration of the CORESET, ControlResourceSet, or the PDCCH, PDCCH-Config), a MAC-CE message or a PHY-layer indication (e.g., via the DCI signaled from a network node).

In certain embodiments, the UE is configured to perform a physical uplink control channel (PUCCH) transmission wherein, the associated PUCCH configuration, or an associated PUCCH resource, resource set or resource group configuration is associated with a value of the TCI-update-Index. The association or linkage is based on the higher layer configuration or indication associated with the aforementioned PUCCH configurations (for e.g., the PUCCH-Config, the PUCCH-ResourceSet, the PUCCH-Resource, or the PUCCH-ResourceGroup that are provided via the RRC), a MAC-CE message or a PHY-layer indication (e.g., via the DCI signaled from a network node).

The association of the channel(s) or the associated resource(s) with a TCI-update-Index, as described above, may be provided via a MAC-CE message.

In certain embodiments, the UE is configured to receive a MAC-CE message, wherein the MAC-CE message indicates an update of the TCI-update-Index associated with one or more channel resources associated with a physical channel. For example, the channel resource(s) may be CORESET(s) associated with a PDCCH or PUCCH resource(s) associated with a PUCCH. The MAC-CE message may comprise at least the following:
one or more identification(s) associated with one or more channel resources of a physical channel, and
a value of a TCI-update-Index or a value that maps to a TCI-update-Index.

The identifications may be one of the following: CORESET ID(s), CORESETpoolIndex value(s), PUCCH resource ID(s), PUCCH resource group ID(s) or PUCCH resource set ID(s). On reception of the MAC-CE message, the UE applies the update of the TCI-update-Index value to associated channel resource(s).

In certain embodiments, the UE is configured to receive a MAC-CE message, wherein the MAC-CE message indicates an update of the TCI-update-Index value associated with one or more channels or one or more transmission occasions of said channel(s). The MAC-CE message comprises at least a value of the TCI-update-Index or a value that maps to the TCI-update-Index. On reception of the MAC-CE message, the UE updates the TCI-update-Index value associated with the transmissions associated with all or a subset of channel(s) and/or channel resource(s) in the CC. In some examples, the UE may receive a MAC-CE message for the update of a TCI-update-Index value for at least the following: a subset of UE-dedicated PUCCH resources in the CC, one or more CORESETs in the CC.

In certain embodiments, a configuration of a grouping of one or more channel resources or resource sets may be obtained by the UE via RRC or MAC-CE, and a value of TCI-update-Index is associated with said grouping of channel resource(s) via RRC or MAC-CE. In some examples, the indication of the TCI-update-Index may be provided with the configuration of the grouping itself. For example, a PUCCH resource grouping or a CORESET grouping may be configured wherein a TCI-update-Index is also provided.

In the above, explicit association of an index was discussed. In the following, indirect or implicit association of the same via other channels or reference signals is discussed.

In certain embodiments, the UE is configured to associate a PDSCH transmission occasion, a PUSCH transmission occasion or a PUCCH resource with the TCI-update-Index or the CORESET pool index value associated with the scheduling or indicating PDCCH.

In some examples, if a PUCCH resource is indicated by a PDCCH associated with a TCI-update-Index or CORESET pool index value u, then the PUCCH resource is also associated with a TCI-update-Index or CORESET pool index value u.

In some examples, if a PDSCH transmission occasion or a PUSCH transmission occasion is scheduled by a PDCCH associated with a TCI-update-Index or CORESET pool index value u, then the PDSCH/PUSCH transmission occasion is also associated with a TCI-update-Index or CORESET pool index value u.

A mapping across indices is also possible with the implicit association mentioned above.

In certain embodiments, the UE is configured to associate a PDSCH transmission occasion, a PUSCH transmission occasion or a PUCCH resource with a value u of a first index if the PDCCH that schedules or indicates it is associated with a value u of a second index. For example, if a PDSCH transmission occasion, a PUSCH transmission occasion or a PUCCH resource is indicated by a PDCCH associated with a CORESET pool index value u, then said PDSCH transmission occasion, PUSCH transmission occasion or PUCCH resource is associated with a TCI-update-Index u. This is also valid with a swapping of the indices between the PDCCH and the scheduled/indicated channels.

An association with a default value of a TCI-update-Index or CORESET pool index may be performed when there is no explicit association signaled from the network or network node.

In certain embodiments, for a CORESET, PDSCH transmission occasion, a PUSCH transmission occasion or a PUCCH resource that is not provided with a TCI-update-Index or CORESET pool index from the network node, the UE is configured to associate a default value of TCI-update-Index or CORESET pool index. For example, the default value may be 0.

Association of an Index with Reference Signals

Similar to the segregation of channels, a segregation of reference signals can be performed.

In certain embodiments, the UE is configured to receive an association of one of the following with a value of the TCI-update-Index via the PHY-layer or a higher layer in a CC:
a synchronization signal/physical broadcast channel (SS/PBCH) block transmission occasion, or a synchronization signal block, SSB, resource or SSB resource set,
a sounding reference signal resource or a sounding reference signal resource set,
a non-zero-power channel state information reference signal resource or a resource set.

In certain embodiments, the association or linkage of the TCI-update-Index with one or more reference signal resources or one or more reference signal resource sets is provided to the UE via a MAC-CE message. The MAC-CE message comprises at least the following:
one or more references to or identifications of said RS resource(s) or resource set(s) (CSI-RS, SSB or SRS), and
a value of a TCI-update-Index or a value that maps to a TCI-update-Index.

After the reception of the aforementioned signaling (PHY-layer signaling, MAC-CE message or a higher layer signaling), the UE applies the update of the TCI-update-Index value to said reference signal resource(s).

In certain embodiments, the association or linkage of the TCI-update-Index with one or more reference signal resources and/or resource sets is configured to the UE via RRC. The configuration of said RS resource(s) or resource set(s) (e.g., CSI-RS, SSB or SRS) is provided to the UE from a network node with a value of the TCI-update-Index.

In certain embodiments, a configuration of a grouping of one or more reference signal resources or resource sets is obtained by the UE via RRC or MAC-CE, and a value of TCI-update-Index is associated with said grouping of reference signal resource(s) via RRC or MAC-CE. In some examples, the indication of the TCI-update-Index may be provided with the configuration of the grouping itself. For example, a list of CSI-RS/SRS/SSB resources or resource sets may be grouped via an RRC configuration, and a TCI-update-Index is provided in the configuration of the grouping itself.

Any method of association of an index, in general, with channel(s), channel resource(s) and/or reference signal(s) in the disclosure may be applicable for the TCI-update-Index, the ‘CORESETpoolIndex’, the SRS resource set identifier (ID) or index and/or the ‘PUCCH resource group index’.

Any method described in the invention disclosure for the indication/configuration/application/update/association/linkage with a value of one of the following indices:
TCI-update-Index,
CORESET pool index,
PUCCH resource group index, or
SRS resource set ID or index,
   for channel(s), channel resource(s) and/or reference signal(s) is also valid with the replacement of said index with one of the other three indices in said method. For example, a method for the indication of an association with a value of TCI-update-Index is also valid with the CORESET pool index, the SRS resource set ID/index or the PUCCH resource group index instead of the TCI-update-Index.

### Association Between Different Indices

As described above, there may be two different indices with which the channels and/or RSs are segregated. A mapping between the channels is performed for the update of the Tx/Rx settings of the channels and RSs. The configuration of the two different indices may be as follows:

In certain embodiments, a first subset of channel(s), channel resource(s) and/or reference signal(s) in a CC is/are associated with value(s) of a first index and a second subset of channel(s), channel resource(s) and/or reference signal(s) in a CC are associated with value(s) of a second index, wherein there is partial or no overlap between the two subsets.

In an example, the first index may be a TCI-update-Index, while the second index is a CORESET pool index, wherein the second subset of channel(s) and/or reference signal(s) may include the PDCCH (i.e., CORESET(s)).

In a second example, the first index may be a TCI-update-Index, while the second index is a PUCCH resource group index, wherein the second subset of second subset of channel(s) and/or reference signal(s) may include the PUCCH.

In a third example, the first index may be a CORESET pool index, while the second index is a PUCCH resource group index, wherein the first subset of channel(s) and/or reference signal(s) may include the PDCCH and the second subset of second subset of channel(s) and/or reference signal(s) may include the PUCCH.

In a fourth example, the first index may be a CORESET pool index, and the second index may be an SRS resource set ID/index, wherein the first subset of channel(s) and/or reference signal(s) may include the PDCCH and the second subset of second subset of channel(s) and/or reference signal(s) may include the SRS.

In the above, explicit association of an index with reference signals was discussed. In the following, indirect or implicit association of the same via other channels or reference signals is discussed.

In certain embodiments, the UE is configured to associate a SRS, CSI-RS or SSB resource or resource set with the TCI-update-Index or the CORESET pool index value associated with the scheduling or indicating PDCCH.

In some examples, if an SRS, CSI-RS or SSB resource or resource set is indicated by a PDCCH associated with a TCI-update-Index or CORESET pool index value u, then the said RS resource is also associated with a TCI-update-Index or CORESET pool index value u.

A mapping across indices is also possible with the implicit association mentioned above.

In certain embodiments, the UE is configured to associate a SRS, CSI-RS or SSB resource or resource set with a value u of a first index if the PDCCH that schedules or indicates it is associated with a value u of a second index. For example, if a SRS resource, a CSI-RS resource or a SSB resource is indicated by a PDCCH associated with a CORESET pool index value u, then said PDSCH transmission occasion, PUSCH transmission occasion or PUCCH resource is associated with a TCI-update-Index u. This is also valid with a swapping of the indices between the PDCCH and the scheduled/indicated RS(s).

An association with a default value of a TCI-update-Index or CORESET pool index may be performed with reference signals as well, as in the case of channels, when there is no explicit association signaled from the network node.

In certain embodiments, for a SRS, CSI-RS or SSB resource or resource set that is not provided with a value of TCI-update-Index or CORESET pool index from the network node, the UE is configured to associate a default value of TCI-update-Index or CORESET pool index. The default value may be fixed in the specifications (known to the UE). For example, the default value may be 0.

Update of the TCI State within a Segregated Set of Channels or Resources

In the above methods, the specific transmission/reception setting(s) of the channel(s), channel resource(s) and/or reference signal(s) may be associated with a value of an index or they may be updated in connection with a value of the associated index/indices. Some possibilities for the update in connection with a TCI-update-Index or a CORESET pool index are as follows:
Indication from a channel with the same value or a mapped value of an index.
Indication of multiple TCI-states via PHY-layer or higher layer signaling wherein each TCI-state is applied for a set of channel(s), channel resource(s) and/or RS(s) associated with a different value of an index (for e.g., via a mapping of values between the indices).
   Separate Update of TCI-State for Channels Associated with Each TCI-Update-Index

In a first method, the UE applies the same TCI-state update for the reception and/or transmission of the channel(s), channel resource(s) and/or reference signal resource(s) associated with the same value of an index.

In certain embodiments, the UE is configured to apply, for a first PDSCH/PDCCH reception or a first PUSCH/PUCCH transmission that is associated with a first value of the TCI-update-Index (or a reception/transmission associated with a configuration that is associated with a first value of the TCI-update-Index), a first TCI-state, and for a second PDSCH/PDCCH reception or a second PUSCH/PUCCH transmission that is associated with a second value of the TCI-update-Index (or a reception/transmission associated with a configuration that is associated with a second value of the TCI-update-Index), a second TCI-state.

Similarly, the UE is configured to apply, for a first CSI-RS/SSB reception or SRS transmission that is associated with a first TCI-update-Index (or a reception/transmission associated with a configuration that is associated with a first TCI-update-Index), a first TCI-state, and for a second CSI-RS/SSB reception or SRS transmission that is associated with a second TCI-update-Index (or a reception/transmission associated with a configuration that is associated with a second TCI-update-Index), a second TCI-state.

The update of the TCI state for channel(s) and/or signal(s) associated with a given value of the TCI-update-Index may be carried out by signaling the TCI-state to the UE only in the channel(s) associated with the same value for the index.

In certain embodiments, the UE is configured to receive a TCI configuration or indication of a TCI-state in a PDCCH to update the TCI-state of one or more channel(s), channel resource(s) and/or reference signal(s), wherein said channel(s), channel resource(s) and/or reference signal(s) whose TCI-state is/are updated are associated with the same TCI-update-Index as the PDCCH.

In certain embodiments, the UE is configured to receive a TCI configuration or indication of a TCI-state in a PDCCH for the update of the TCI-state of one or more channel(s) and/or reference signal(s), wherein the PDCCH is associated with a CORESET pool index value that is mapped to the TCI-update-Index value associated with the channel(s) and/or reference signal(s) whose TCI-state is updated. For example, the TCI-state for a channel or reference signal associated with a TCI-update-Index ‘a’ is indicated by a PDCCH that is associated with a CORESET pool index value ‘b’. Then the TCI-update-Index value ‘a’ is said to be mapped to CORESET pool index value ‘b’.

In certain embodiments, the UE is configured to receive a TCI configuration or indication of a TCI-state in a PDCCH for the update of the TCI-state of one or more channel(s) and/or reference signal(s), wherein the PDCCH is associated with a CORESETpoolindex value that is identical to the TCI-update-Index value of the channel(s) and/or reference signal(s) whose TCI-state is updated. For example, the TCI-state for a channel or reference signal associated with a TCI-update-Index ‘a’ is indicated by a PDCCH that is associated with a CORESET pool index value ‘a’.

In certain embodiments, the UE receives an indication of at least one TCI-state indicated in a PDCCH or a higher layer signaling that is associated with a value of an index (e.g. TCI-update-Index) and applies a transmission setting and/or reception setting provided in at least one of the indicated TCI-state(s) to at least one of the following in at least one CC:
a PDCCH associated with the same value of the index,
a PDSCH associated with the same value of the index or a PDSCH scheduled by a PDCCH/DCI associated with the same value of the index,
a PUSCH associated with the same value of the index or a PUSCH scheduled by a PDCCH/DCI associated with the same value of the index,
a PUCCH resource associated with the same value of the index, or a PUCCH resource indicated in a PUCCH resource indicator field of a PDCCH/DCI associated with the same value of the index.

In certain embodiments, the UE receives an indication of one or more TCI-states indicated in a PDCCH or higher layer signaling that is associated with a value of first index and applies a transmission setting and/or reception setting provided in at least one of the indicated TCI-states to at least one of the following in at least one CC:
a PDCCH associated with the same value of said first index,
a PDSCH associated with the same value of said first index or a different index or a PDSCH scheduled by a PDCCH/DCI associated with the same value of said first index,
a PUSCH associated with the same value of said first index or a different index or a PUSCH scheduled by a PDCCH/DCI associated with the same value of said first index,
a PUCCH resource associated with the same value of said first index or a different index, or a PUCCH resource indicated in a PUCCH resource indicator field of a PDCCH/DCI associated with the same value of said first index.

In certain embodiments, the UE receives an indication of one or more TCI-states indicated in a PDCCH or higher layer signaling that is associated with a value of first index and applies a transmission setting and/or reception setting provided in at least one of the indicated TCI-states to at least one of the following in at least one CC:
a PDCCH associated with the same value of said first index,
a PDSCH associated with second value of a different index or a PDSCH scheduled by a PDCCH/DCI associated with the same value of said first index,
a PUSCH associated with a second value of a different index or a PUSCH scheduled by a PDCCH/DCI associated with the same value of said first index,
a PUCCH resource associated with a second or third value of a different index, or a PUCCH resource indicated in a PUCCH resource indicator field of a PDCCH/DCI associated with the same value of said first index.

The ‘second value’ or ‘third value’ of another index mentioned above may be considered to be mapped to the first value of the first index.

The application of TCI-state to individual channel transmission occasions was presented above. The sets of channel transmission to which the indicated TCI-states may apply is presented below.

In certain embodiments, the UE receives an indication of a one or more TCI-states in a PDCCH/DCI or higher layer signaling that is associated with a value of an index (e.g. TCI-update-Index) and applies a transmission setting and/or reception setting provided in at least one of the indicated TCI-states to at least one of the following in at least one CC:
PDCCH(s) associated with the same value of the index,
UE-dedicated PUCCH resource(s) in a CC associated with the same value of the index or indicated by a PDCCH/DCI associated with the same value of the index,
Physical downlink shared channel(s), PDSCH(s), associated with the same value of the index or scheduled by PDCCH(s) associated with the same value of the index,
physical uplink shared channel(s), PUSCH(s), associated with the same value of the index or scheduled by PDCCH(s) associated with the same value of the index.

In certain embodiments, the UE receives an indication of a one or more TCI-states in a PDCCH or higher layer signaling that is associated with a value of a first index and applies a transmission setting and/or reception setting provided in at least one of the indicated TCI-states to at least one of the following in at least one CC:
PDCCH(s) associated with the same value of said first index,
UE-dedicated PUCCH resource(s) in a CC associated with the same value of said first index or a different index or indicated by a PDCCH associated with the same value of said first index,
physical downlink shared channel(s), PDSCH(s), associated with the same value of a said first index or a different index or scheduled by PDCCH(s) associated with the same value of said first index,
physical uplink shared channel(s), PUSCH(s), associated with the same value of a said first index or a different index or scheduled by PDCCH(s) associated with the same value of said first index.

In certain embodiments, the UE receives an indication of one or more TCI-states in a PDCCH or higher layer signaling that is associated with a value of a first index and applies a transmission setting and/or reception setting provided in at least one of the indicated TCI-states to at least one of the following in at least one CC:
PDCCH(s) associated with the same value of said first index,
UE-dedicated PUCCH resource(s) in a CC associated with a second or a third value of a different index or indicated by a PDCCH associated with the same value of said first index,
physical downlink shared channel(s), PDSCH(s), associated with a second value of a different index or scheduled by PDCCH(s) associated with the same value of said first index,
physical uplink shared channel(s), PUSCH(s), associated with a second value of a different index or scheduled by PDCCH(s) associated with the same value of said first index.

The ‘second value’ of another index mentioned above may be considered to be mapped to the first value of the first index.

In any of the embodiments above, the term ‘different index’ may mean an index/parameter different from the ‘first index’ mentioned in them.

In an example of the above methods, the UE may receive an indication of one DL TCI-state, one UL TCI-state, one joint TCI-state or a pair of TCI-states where one is a DL TCI-state and the other is a UL TCI-state. As mentioned earlier, the applicability to the channels listed in the methods may depend on the type of TCI-state(s) indicated.

In certain embodiments, the PDCCH(s) providing the TCI-state(s) indication and/or the PDCCH(s) that schedule(s) or indicate(s) the aforementioned PDSCH(s), PUSCH(s) or PUCCH resource(s), are associated with UE-specific search space set(s) or CORESET(s) that are associated with at least one UE-specific search space set.

In certain embodiments, the PDCCH providing the TCI-state(s) indication for said channel(s), channel resource(s) and/or reference signal(s) is different from the PDCCH that schedules or indicates said channel(s), channel resource(s) and/or reference signal(s). In this way, the separation of the settings indication and the scheduling is performed, enabling modular implementation of the network.

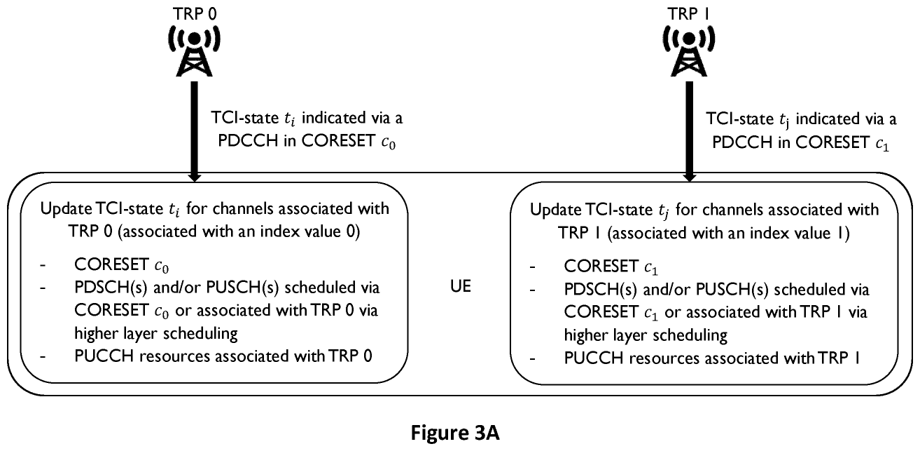

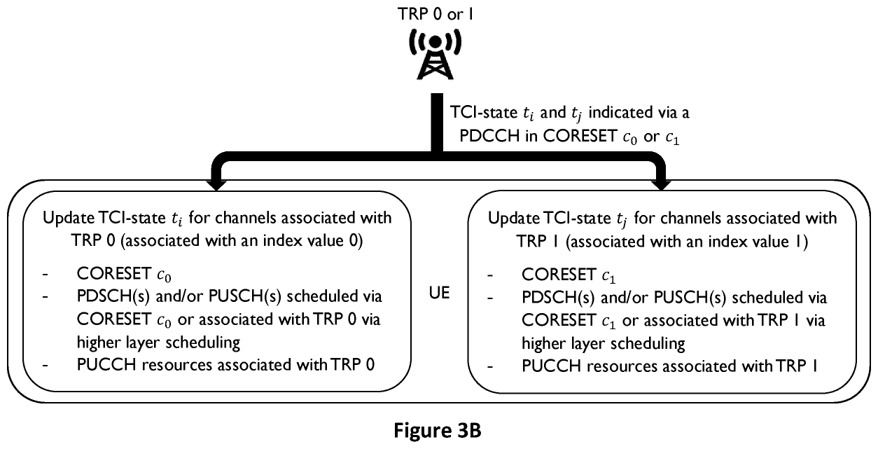

An example implementation of the TCI-update of the channels associated with a specific value of a one or more different indices via TCI-state indication in PDCCHs associated with the same value of its associated index is shown in FIG. 3A. Each channel may be associated with a different index. For example, PDCCH may be associated with CORESET pool index values while PDSCH, PUSCH or PUCCH are associated with either a CORESET pool index, TCI-update-Index or PUCCH resource group index.

FIG. 3A shows TCI-state update at a UE for channels corresponding to different TRPs (in this example TRP 0 and TRP 1) via PDCCHs associated with respective TRPs. The index associated with each channel may be different.

As shown in the example of FIG. 3A, TRP 0 (or network node 0) transmits to the UE in the downlink direction, a PDCCH in CORESET c₀ which indicates a TCI-state ti. The UE then updates the TCI-state for the following channels associated with TRP 0 (associated with an index value 0):
CORESET c₀
PDSCH(s) and/or PUSCH(s) scheduled via CORESET c₀ or associated with TRP 0 via higher layer scheduling
PUCCH resources associated with TRP 0

Similarly, TRP 1 (or network node 1) transmits to the UE in the downlink direction, a PDCCH in CORESET c₁ which indicates a TCI-state tp. The UE then updates the TCI-state for the following channels associated with TRP 1 (associated with an index value 1):
CORESET c₁
PDSCH(s) and/or PUSCH(s) scheduled via CORESET cᵢ or associated with TRP 1 via higher layer scheduling
PUCCH resources associated with TRP 1

Note: In any method in this disclosure, ‘a single TCI indication’ or ‘an indication of a TCI-state’ or ‘at least one TCI state indication’ received by the UE via a PDCCH or a higher layer indication (e.g., MAC-CE message or RRC) means the reception of one of the following during one occasion or instance of the signaling:
one downlink TCI-state,
one uplink TCI-state,
one downlink TCI-state and one uplink TCI-state, or
one TCI-state that jointly provides downlink and uplink setting(s),

The TCI-state(s) are applied to any associated/said downlink and/or uplink channel(s) and/or reference signal(s) depending on the type of TCI configuration(s) provided in the PDCCH—downlink TCI configuration applies only to DL channel(s) and/or RS(s), uplink TCI configuration applies only to UL channel(s) and/or RS(s), a TCI configuration jointly providing DL and UL settings applies to at least one DL channel and/or DL RS and at least one UL channel and/or UL RS.

If the received TCI-state is a downlink TCI-state comprising DL reception setting(s), only the TCI-state of the PDSCH and/or the PDCCH from the lists of channel(s) presented in the above methods may be updated. If the received TCI-state is an uplink TCI-state, i.e., comprising UL transmission setting(s), only the TCI-state of the PUSCH and/or the PUCCH from the above lists may be updated. If one DL TCI-state and one UL TCI-state are received, the TCI-states of all four channels from the above lists are updated—the DL TCI-state is applied to the DL channels and the UL TCI-state is applied to the UL channels. If a joint TCI-state is received, the Tx settings in it are applied to the UL channels and the Rx settings in it are applied to the DL channels. In addition, the TCI-state of some reference signals may also be updated along with the TCI-state indication.

In an embodiment, the UE receives an indication of at least one TCI-state in a PDCCH that is associated with a value u of TCI-update-Index and applies a transmission setting and/or reception setting in at least one of the indicated TCI-states to at least one of the following:
a CSI-RS resource or a CSI-RS resource set associated with a TCI-update-Index value u
an SRS resource or an SRS resource set associated with a TCI-update-Index value u.

In an embodiment, the UE receives an indication of at least one TCI-state in a PDCCH that is associated with a value of a first index and applies a transmission setting and/or reception setting in at least one of the indicated TCI-states to at least one of the following:
a channel state information reference signal, CSI-RS, resource or a CSI-RS resource set associated with the same value of a first index or a different index,
a sounding reference signal, SRS, resource or an SRS resource set associated with the same value of a first index or a different index.

In an embodiment, the UE receives an indication of at least one TCI-state in a PDCCH that is associated with a value of a first index and applies a transmission setting and/or reception setting in at least one of the indicated TCI-states to at least one of the following:
a channel state information reference signal, CSI-RS, resource or a CSI-RS resource set associated with a second value of a second index mapped to said first value of first index,
a sounding reference signal, SRS, resource or an SRS resource set associated with a second value of a second index mapped to said first value of first index.

The CSI-RS resource(s) or CSI-RS resource set(s) whose TCI-state is updated may be the one(s) provided in a CSI report configuration. Their association with a TCI-update-Index may be determined by the UE based on network indication via the PHY-layer or a higher layer or based on UE reporting to the network. The type of SRS resource(s) or SRS resource set(s) whose TCI-state is updated may be ‘codebook’, ‘noncodebook’ or ‘antennaSwitching’. A proper subset of configured SRS resources for beam management in a set may also be updated with said TCI-state.

The SRS resource(s) or SRS resource set(s) whose TCI-state is updated may be the one(s) associated with the first TCI-update-Index via a network indication to the UE or UE reporting to the network.

The methods above are also applicable with a change of the index from the TCI-update-Index for the indicating PDCCH and/or one or more of the channel(s), channel resource(s) and/or reference signal(s) applied with the indicated TCI-state(s). For example, the PDCCH (i.e., CORESET(s)) indicating the TCI-state(s) may be associated with a TCI-update-Index and one or more of the channel(s), channel resource(s) and/or resource(s) applied with the indicated TCI-state(s) may be associated with a CORESET pool index, and vice versa. In such cases, a mapping between the two different indices is available at the UE or provided to the UE and the UE applies the TCI-state indicated in the PDCCH to the channel(s) and/or resource(s) that are associated with a value of the index (TCI-update-Index or CORESET pool index) that is mapped to the value of the index (CORESET pool index or TCI-update-Index) associated with the PDCCH. The mapping may be performed based on the value of the indices being identical, i.e., a CORESET pool index with value u may be mapped with a TCI-update-Index with value u as well. For example, the TCI-state(s) indicated by a PDCCH associated with a CORESET pool index value or a TCI-update-Index value ‘a’ may be applied to said channel(s), channel resource(s) and/or reference signal(s) associated with a CORESET pool index value or a TCI-update-Index value ‘a’.

The principle used in the above methods is as follows: if a PUCCH, PUSCH or PDSCH is associated with a given value of an index via higher layer configuration/indication or indirectly via a scheduling/indicating PDCCH, then a TCI-state indicated by a PDCCH with the same value of the same index or a different index or via a mapping or values between different indices is applied to said PUCCH, PUSCH or PDSCH. The restriction to UE-dedicated PDCCH, in some cases, is to differentiate from PDCCH that is common to multiple UEs, for which a common TCI-state update may not be functionally suitable.

Joint Update of TCI-State for Multiple Groups of Channel(s) and/or RS(s)

In the following, a joint indication of the TCI-states associated with multiple values of an index is provided.

In certain embodiments, the UE is configured to receive via a PDCCH or higher layer signaling an indication of M≥2 TCI-state(s), and upon its reception, it applies a first indicated TCI-state to one or more channel(s), channel resource(s) and/or reference signal(s) that is/are associated with a pre-determined or an indicated first value of an index and a second TCI-state to one or more channel(s) and/or signal(s) that is/are associated with a pre-determined or an indicated second value of an index.

Here, ‘pre-determined’ means that the value of the index that the TCI-state maps to is known to the UE and/or provided in the standard specifications. In the case of indication of the value of an index to which the TCI-state is to be applied, the network provides the value of an index that the TCI-state maps to via a PHY-layer and/or higher layer signaling. In some examples, the indication of said value may be provided in the same signaling as the TCI-state(s) indication itself.

In certain embodiments, the UE is configured to receive via a PDCCH or higher layer signaling an indication of a TCI-state, and upon its reception, it applies the indicated TCI-state to one or more channel(s), channel resource(s) and/or reference signal(s) that is/are associated with a pre-determined or an indicated value of the index.

In accordance with embodiments, the UE is configured to receive a PHY-layer or higher layer signaling with an indication of M=1 TCI-state, and upon its reception, the UE is configured to perform TCI-state update of one or more channel(s), channel resource(s) and/or reference signal(s) that are associated with an index value 0 or the lowest applicable value for the index associated with said channel(s), channel resource(s) and/or RS(s). This helps in establishing a default behavior for a PDCCH enabled with multi TCI-state indication.

In accordance with embodiments, the UE is configured to receive a PHY-layer or higher layer signaling with an indication of M≥1 TCI-states along with M values of an index or M values that map to M different values of one or more indices.

Upon its reception, the UE is configured to perform, for one or more channel(s), channel resource(s) and/or reference signal(s) associated with an indicated i-th value of the associated index, a TCI-state update with the i-th indicated TCI-state. For example, if 2 TCI-states are indicated along with two values u₁ and u₂, then the first TCI-state is applied to channel(s) and/or reference signal(s) associated with an index (e.g., CORESET pool index, TCI-update-Index, PUCCH resource group index, SRS resource set/D/index) value u₁ and the second TCI-state is applied to channel(s) and/or reference signal(s) associated with an index value u₂.

The one or more channel(s) for which a TCI-state is updated may be at least one of the following in at least one CC:
PDCCH(s) associated with a predetermined or indicated value u of an index,
UE-dedicated PUCCH resource(s) in a CC associated with or indicated by PDCCH(s) associated with a predetermined or indicated value u of an index,
PDSCH(s) associated with or scheduled by PDCCH(s) associated with a predetermined or indicated value u of an index,
PUSCH(s) associated with or scheduled by PDCCH(s) associated with a predetermined or indicated value u of an index.

In some examples, the PDCCH(s) providing the TCI-state(s) signaling and/or the PDCCH(s) that schedule or indicate the aforementioned PDSCH(s), PUSCH(s) or PUCCH resource(s), are associated with UE-specific search space set(s) or CORESET(s) that are associated with at least one UE-specific search space set.

The one or more reference signal(s) for which a TCI-state is updated may be at least one of the following in at least one CC:
CSI-RS resource(s) or CSI-RS resource set(s) associated with a predetermined or indicated value u of an index,
SRS resource(s) or SRS resource set(s) associated with a predetermined or indicated value u of an index.

In the methods above, the ‘indicated value u’ may denote an index value indicated using any of the signaling(s) described above. A ‘predetermined value u’ may determine an index value that a given TCI-state is predetermined/fixed in the specifications to be applied.

The CSI-RS resource(s) or CSI-RS resource set(s) whose TCI-state is updated may be the one(s) provided in a CSI report configuration. Their association with a TCI-update-Index may be determined by the UE based on network indication via the PHY-layer or a higher layer or based on UE reporting to the network. The type of SRS resource(s) or SRS resource set(s) whose TCI-state is updated may be ‘codebook’, ‘noncodebook’ or ‘antennaSwitching’. A proper subset of configured SRS resources for beam management in a set may also be updated with said TCI-state.

In an alternative method, the UE receives a MAC-CE message or a higher layer signaling that comprises an identification or an index that refers to at least one TCI-state along with an indication of a value of TCI-update-Index and/or CORESET pool index. In such cases, channel(s) and/or resource(s) associated with said TCI-update-Index and/or CORESET pool index value are updated with said at least one TCI-state.

The separation of the TCI-state signaling and the scheduling tasks makes the network implementation easier.

In certain embodiments, the UE is configured to receive from a network node an indication of said TCI-state(s) via a first PDCCH, a MAC-CE message or a higher layer signaling, and further receiving a scheduling or indication, via one or more second PDCCHs or higher layer signaling, of at least one of the following:
PUSCH, PUCCH or PDSCH transmission occasion(s),
CSI-RS, SRS or SSB resources or resource sets,
   and apply the TCI-state(s) from the first PDCCH/MAC-CE message/higher layer signaling to applicable channel and/or RS transmission(s) scheduled by the second PDCCH or higher layer signaling. The TCI-state and/or spatial relation indication for the scheduled or indicated channel(s), channel resource(s) and/or RS(s) may not be provided in the scheduling PDCCH(s) or higher layer signaling(s).

In some examples, the TCI-states indicated by the first PDCCH may be applied to PDCCH(s) after the reception of the first PDCCH.

An example implementation of the TCI-update of the channels associated with a specific value of a one or more different indices via TCI-state indication in a single PDCCH is shown in FIG. 3B.

FIG. 3B shows TCI-state update for channels corresponding to the same TRP (in this example TRP 0 or TRP 1) via a PDCCH associated with a single TRP (TRP 0 or TRP 1).

As shown in the example of FIG. 3B, TRP 0 or TRP 1 transmits to a UE in the downlink direction, in one PDCCH in CORESET c₀ or in CORESET c₁ which indicates a TCI-state ti and TCI-state tⱼ.

The UE then updates the TCI-state ti for the following channels associated with the same TRP 0 (or TRP 1) (associated with an index value 0):
CORESET c₀
PDSCH(s) and/or PUSCH(s) scheduled via CORESET c₀ or associated with the same TRP 0 (or TRP 1) via higher layer scheduling
PUCCH resources associated with the same TRP 0 (or TRP 1)

The UE also updates the TCI-state tⱼ. for the following channels associated with the same TRP 0 (or TRP 1) (associated with an index value 1):
CORESET c₁
PDSCH(s) and/or PUSCH(s) scheduled via CORESET cᵢ or associated with the same TRP 0 (or TRP 1) via higher layer scheduling
PUCCH resources associated with the same TRP 0 (or TRP 1)

The index associated with each channel in a group (channels updated with the same TCI-state) may be same or different. However, the values for the indices within the group are the same.

Note: In this disclosure, the indication of Q≥1 TCI-states via a PHY-layer (PDCCH/DCI) or higher layer signaling (e.g., MAC-CE or RRC) may imply the indication of one of the following in one transmission occasion or instance of said PHY-layer or higher layer signaling:
Q downlink TCI-state(s),
Q uplink TCI-state(s),
Q_{D}≥1 downlink TCI-states(s) and Q_{U}≥1 uplink TCI-states, wherein
   Q_{D}=Q_{y}=Q, (for e.g., Q pairs of TCI-states, each pair comprising an UL TCI-state and a DL TCI-state), or
   Q_{D}=Q and Q_{U}<Q, or
   Q_{U}=Q and Q_{D}<Q
Q TCI-state(s) that jointly provide downlink and uplink setting(s).

It is to be noted that the cases where Q_{U}<Q or Q_{D}<Q may be applicable only when Q≥2. In some examples where Q_{U}<Q or Q_{D}<Q, Q_{U} or Q_{D} may be equal to 1.

In any method with TCI-state indication (Q≥1 TCI-state(s)) in this disclosure, if the TCI-state(s) indicated is/are UL TCI-state(s), it/they applies/apply only to the UL channel(s) and/or RS(s) from the applicable channel(s) and/or RS(s) described in the method. Similarly, if the TCI-state(s) indicated is/are DL TCI-state(s), it/they applies/apply only to the DL channel(s) and/or RS(s) from the applicable channel(s) and/or RS(s) described in the method. In the case of TCI configurations that provide DL and UL setting(s) jointly, they apply to at least one applicable DL channel and/or DL RS and at least one possible applicable UL channel and/or UL RS described in the method.

In any method with possible TCI-state indication (Q≥1 TCI-state(s)), it may mean the indication of Q pairs of TCI-states, each pair comprising an UL TCI-state and a DL TCI-state. The ‘application/update of a TCI-state’ or ‘application/update of the Tx/Rx setting(s) in a TCI-state’ in a method to one or more channel(s), channel resource(s) and/or RS(s) may mean the application of a pair of DL TCI-state and UL TCI-state to said one or more channel(s), channel resource(s) and/or RS(s) wherein the DL TCI-state may apply to DL channel(s), channel resource(s) and/or RS(s) in said one or more channel(s), channel resource(s) and/or RS(s), and the UL TCI-state may apply to UL channel(s), channel resource(s) and/or RS(s) in said one or more channel(s), channel resource(s) and/or RS(s).

In an additional note, for any method in the disclosure that applies to one or more channels and/or RSs that are all in uplink or one or more channels and/or RSs that are all in downlink, then an associated TCI-state indication may comprise the indication of TCI-state(s) that are associated with only uplink setting(s) or only downlink setting(s), respectively. A joint TCI-state (a TCI configuration that comprises both UL and DL setting(s)) may not be indicated or applicable in such scenarios. For partial applicability of a joint TCI-state in a given situation/scenario or a CC, i.e., the application of a joint TCI-state only to UL channel(s) and/or RS(s) or the application of a joint TCI-state only to DL channel(s) and/or RS(s), network indication may be necessary (e.g., via higher layer such as MAC-CE message or RRC signaling).

It should also be noted that:
Any method of update/application of Tx and/or Rx settings, or TCI-state(s) in connection with an index for channel(s), channel resource(s) and/or reference signal(s), in general, are applicable for the TCI-update-Index, the ‘CORESETpoolIndex’, the SRS resource set ID/index and/or the ‘PUCCH resource group index’.
Any method described in the disclosure for the update/application of Tx and/or Rx settings, or TCI-state(s) in connection with a value of one of the following indices:
   TCI-update-Index,
   CORESET pool index,
   PUCCH resource group index or
   SRS resource set ID/index
for channel(s), channel resource(s) and/or reference signal(s) are also valid with the replacement of said index with one of the other three indices in said method. For example, a method for update/application of Tx and/or Rx settings, or TCI-state(s) in connection with a value of TCI-update-Index is also valid with the CORESET pool index, SRS resource set index or the PUCCH resource group index instead of the TCI-update-Index.

In the methods described above for the use of indices to segregate channels and use them for the indication of the TCI-states for various groupings of channels, channel resources and/or RSs provides the advantages that it enables easier multilink network implementations and also it reduces control information overhead. The embodiments of the present invention disclosure provide a high practical utility due to the following:
The use of multiple indices across various channels and/or RSs is introduced in this disclosure along with methods to perform a mapping between them, which is helpful in the connection of various use-cases of network implementation. For example, a set of channels and/or RSs segregated with respect to two or more panels at the UE may be provided a mapping with a set of channels and/or RSs segregated with respect to two or more TRPs in the network that the UE communicates with. Such co-existence between use-cases increases the number of possibilities of network deployment.
The dynamic modification of the association of the indices associated with channels and RSs proposed in the invention disclosure is useful in reorganization of the network and/or UE communication on-demand.
The separation of the scheduling and TCI-state indication in the network is a significant move away from the current 5G NR standards which helps in the easier implementation of the two different functionalities of the network and removes the necessity for constant indication of the TCI-state(s) during every instance of scheduling.
   Multiple TCI-States Indication Via Implicit Segregation or within Segregated Channels/RSs

In the case that there is no segregation of the channels, i.e., a higher layer configuration does not explicitly segregate the channels, but in-terms of the TCI-state they are mapped to. This would assure transmissions to/from different TRPs via TCI-state mapping only instead of explicit segregation. Moreover, it is possible to split the TCI-indication and the scheduling of the channels, the network is able to modularize the two different functionalities during implementation.

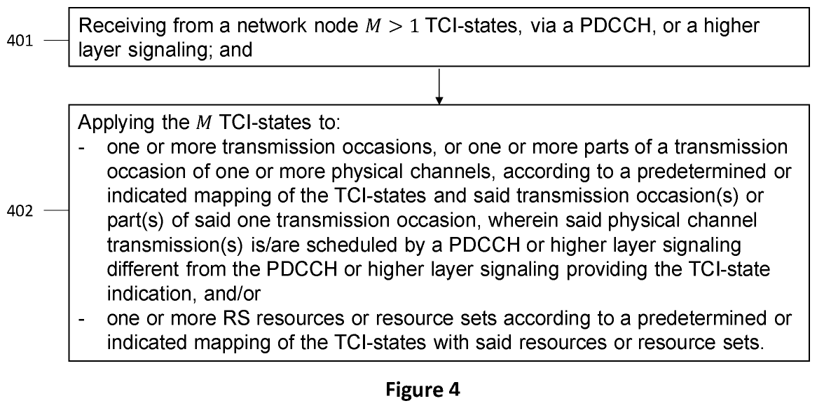

According to additional embodiments of this invention disclosure, there is provided a method performed by a UE as shown in FIG. 4, the method comprising,
receiving (401) from a network node M≥1 TCI-states via a PDCCH or a higher layer signaling, and
applying (402) the M TCI-states to:
   one or more transmission occasions, or one or more parts of a transmission occasion of one or more physical channels, according to a predetermined or indicated mapping of the TCI-states and said transmission occasion(s) or part(s) of said one transmission occasion, wherein said physical channel transmission(s) is/are scheduled by said PDCCH or higher layer signalling different from the PDCCH or higher layer signalling providing the TCI-state indication, and/or
   one or more RS resources or resource sets according to a predetermined or indicated mapping of the TCI-states with said resources or resource sets.

According to an embodiment, at least one part of said physical channel is associated with different port(s) and/or frequency-domain resources and/or time domain resources from at least one other part of the physical channel.

The physical channel may be a physical downlink or uplink shared channel (PDSCH), or the RS resource may be physical uplink control channel (PUCCH) resource. The M TCI-states are applied to N≥M repetitions of the PUCCH resource according to a predetermined or indicated mapping of the TCI-states and the repetitions.

As indicated in a previously disclosed embodiment, the UE is configured to receive or perform an association of the one or more uplink, UL, and/or downlink, DL, channel(s) and/or reference signal(s) with a value of an index or a parameter.

The physical channel(s) and/or reference signal(s) to which the TCI-states are applied and the scheduling PDCCH or higher layer signaling that schedules it are:
associated with the same value of an index, or
associated with different indices, wherein a mapping between the value of the index of the scheduling PDCCH and the value of an index of the physical channel(s) and/or reference signal(s) the TCI-states are applied to exists.

In an exemplary embodiment, the physical channel(s) and/or reference signal(s) to which the TCI-states are applied and/or the scheduling PDCCH or higher layer signaling that schedules it is/are not associated with an index.

As previously described, the UE receives an indication of M≥1 TCI-states via a PDCCH or a higher layer signaling. According to another embodiment, the M TCI-states may be applied to at least one of the following:
N≥M PDSCH transmission occasions scheduled by a single PDCCH according to a predetermined or indicated mapping of the TCI-states and the transmission occasions,
N≥M different parts of a PDSCH, wherein at least one part of said PDSCH is associated with a different port and/or frequency-domain resources and/or time domain resources from at least one other part of the PDSCH,
N≥M PUSCH transmission occasions scheduled by a single PDCCH or a single higher layer configuration grant according to a predetermined or indicated mapping of the TCI-states and the transmission occasions,
N≥M repetitions of a PUCCH resource according to a predetermined or indicated mapping of the TCI-states and the repetitions.

The PUCCH indication in the method above may be obtained on a single PDCCH or a higher layer configuration.

For scheduling individual PDSCH, PUCCH or PUSCH transmissions to different TRPs, the signaling of the TCI-states may be present in the scheduling PDCCH or higher layer grant itself. However, splitting the scheduling and the indication of the TCI-states reduces the overhead of indicating the TCI-states for each scheduling occasion and also paves way for unified Tx/Rx setting signaling.

In certain embodiments, the UE is configured to receive from a network node an indication of TCI-state(s) via a first PDCCH, a MAC-CE message or a higher layer signaling, and a scheduling or indication, via one or more second PDCCHs or higher layer signaling, of at least one of the following:
PUSCH, PUCCH or PDSCH transmission occasion(s),
CSI-RS, SRS or SSB resources or resource sets,
   and apply the TCI-state(s) from the first PDCCH/MAC-CE message/higher layer signaling to applicable channel and/or RS transmission(s) scheduled by the second PDCCH or higher layer signaling.

The above method may be applied when at least one of the following conditions are satisfied:
at least one of PUSCH, PUCCH, PDCCH or PDSCH is not associated or configured with an index,
at least one of CSI-RS, SRS or SSB is not associated or configured with an index,
the PDCCH or the scheduling higher layer signaling is not associated with an index.

The mapping of the TCI-states may be predetermined via higher layer configuration or it may be provided in the 3GPP specifications.

In certain embodiments, the UE is configured to receive from a network node an indication of M≥1 TCI-states via a PDCCH or a higher layer signaling, wherein the M TCI-states are applied to at least one of the following:
A first TCI-state is applied to a part of a PDSCH transmission associated with a first set of DMRS ports associated with a first code-division-multiplexing (CDM) group and a second TCI-state is applied to a part of a PDSCH transmission associated with a second set of DMRS ports associated with a second CDM group and so on.
A first TCI-state is applied to a first PDSCH transmission occasion associated with a first set of time and/or frequency domain resources and a second TCI-state is applied to a second PDSCH transmission occasion associated with a second set of time and/or frequency domain resources that are distinct from the first set of time and/or frequency resources and so on.
A first TCI-state is applied to a first transmission occasion of a PUSCH associated with a first SRS resource indicator value or a first SRS resource set, and a second TCI-state is applied to a second transmission occasion of a PUSCH associated with a second SRS resource indicator value or a second SRS resource set and so on.
A first TCI-state is applied to a first transmission occasion of a PUCCH resource associated with a first set of time and/or frequency domain resources and a second TCI-state is applied to a second transmission occasion of the same PUCCH resource associated with a second set of time and/or frequency domain resources that are distinct from the first set of time and/or frequency resources and so on.

In certain embodiments, the UE is configured to receive a higher layer signaling indicating at least one of the following:
two or more PDSCH transmission occasions may occur for a PDSCH, that are separated in time and/or frequency and are associated with two or more TCI-states, wherein the TCI-states are obtained from a PDCCH or higher layer signalling different from the signaling that schedules the PDSCH transmission occasions.
one or more PDSCH transmission occasions for a PDSCH wherein each occasion may be associated with two or more TCI-states, wherein the TCI-states are obtained from a signaling different from the signaling that schedules the PDSCH.
two or more PUSCH transmission occasions may occur for a PUSCH, that are separated in time and/or frequency that are associated with two or more TCI-states, wherein the TCI-states are obtained from a signaling different from the signaling that schedules the PUSCH transmission occasions.

The PDSCH(s) or the PUSCH(s) scheduled by the PDCCH or higher layer configuration/grant in any of the above methods may be associated with the same hybrid automatic repeat request (HARQ) process ID or be repetitions of the same transport block(s) (TB(s)). In another scenario, the UE may be configured with the higher layer parameter ‘repetitionScheme’ in any of the above methods, wherein the parameter is set to a value of ‘fdmSchemeA’, ‘fdmSchemeB’ or ‘tdmSchemeA’, where ‘fdm’ stands for ‘frequency division multiplexing’, and ‘tdm’ stands for ‘time division multiplexing’.

When the UE receives, from a network node, an indication of M≥1 TCI-states via a PDCCH or a higher layer signaling, the UE may apply a first TCI-state to a first SRS resource in a given SRS resource set and a second TCI-state to a second SRS resource in the same SRS resource set.

In accordance with an embodiment, the UE may apply a first TCI-state to at least one SRS resource in a first SRS resource set and a second TCI-state to at least one SRS resource in a second SRS resource set. In some examples, the TCI-state may be applied to all the SRS resources in the applicable SRS resource sets.

In the above methods for the application of the TCI-state to the SRS, the application of a TCI-state may mean that at least one of the following settings associated with the TCI-state is applied to said SRS resources or resource sets:
a pathloss reference RS setting
a spatial relation setting
a power control setting comprising one or more power control parameters

It should be noted that when there is no segregation, then it is possible that the PDCCH originates only from a single TRP. Therefore, one of the TCI-states from the indicated multiple TCI-states may be used for the PDCCH. The CORESETs in this case may not be configured or associated with a CORESET pool index value.

In certain embodiments, when the UE receives from the network node, an indication of M≥1 TCI-states via a PDCCH or a higher layer signaling, the UE is configured to apply one of the TCI-states for the reception of at least one PDCCH on at least one CORESET. In some examples, the applied TCI-state may be the one with the lowest or highest ID among the M indicated TCI-states.

In a special case, the chosen TCI-state may be applied to all the CORESET(s) (in the active DL bandwidth part, BWP, of the target CC(s)). In another case, the chosen TCI-state may be applied to CORESET(s) that are associated with at least one user-specific search space set.

### UE Reporting of Index Association

The association of a CSI-RS resource/resource set with an index may be enabled by different means: a direct association by means of explicit network indication with a value of an index or an indirect or implicit association wherein the UE performs an association and/or reporting the associated value of an index. The indirect or implicit association may be performed by associating the CSI-RS resource or resource set with a value or index that has an association with a TCI-update-Index value. For example, an SRS resource set ID or a UE capability value (for e.g., a value corresponding to the UE port/panel configuration at the UE such as number of SRS ports, number of SRS resources in a set, etc.) may be associated with a TCI-update-Index value and associating that with a CSI-RS resource or resource set would indirectly or implicitly associate it with a TCI-update-Index value.

In accordance with an embodiment the UE is configured to report to a network node (e.g., gNB), an association of a CSI-RS resource or resource set, an SSB resource or resource set, or an SRS resource or resource set with at least one of the following:
a value of an index, or
a UE capability value.

The index may be CORESET pool index, TCI update index, PUCCH resource group index or SRS resource set index (in case the association is with a CSI-RS or SSB).

In accordance with an embodiment, the UE is configured to report to the network node (e.g., gNB), an association of a CSI-RS resource or resource set, or an SSB resource or resource set, with at least one of the following:
an index or identification of an SRS resource (for e.g., SRI) or an SRS resource set,
a value of an index (for e.g., CORESET pool index, TCI update index or PUCCH resource group index), or
a UE capability value.

The above reporting may be performed via RRC, a MAC-CE message or via a PUSCH/PUCCH transmission (for e.g., as a part of a CSI report or a beam report). The UE capability value mentioned above may be a value from a list of values that the UE has reported to a network for a certain UE capability parameter.

From the above reporting, the association of an index and a DL RS or DL RS resource set may be determined at the UE and/or gNB so that the TCI-state may be updated accordingly.

Similarly, the UE may choose to update the association of an SRS resource or resource set with a value of an index.

The association of an RS resource or resource set with a TCI-update-Index value or a CORESET pool index value may be retained until the association is updated by the UE reporting.

### Co-Existence of Different Multi-TRP Schemes

An extension of above methods would be the co-existence of different MTRP schemes across various channels. The co-existence of different multi-TRP schemes for various channels should be analysed based on the two possible modes of indication of the TCI-states:
A single DCI indicates the TCI-states corresponding to two different TRPs,
Each DCI indicates one TCI state with respect to its associated TRP.

The configuration of a CORESET pool index for one or more CORESETs is one of the differentiating aspects between the aforementioned multi-TRP transmission modes. If CORESET pool index is configured for one or more CORESETs, then a DCI may indicate TCI-state(s) only with respect to its associated TRP.

Single-DCI-Based Multi-TRP TCI-State Indication with Co-Existence

For the single-DCI based multi-TRP TCI-state indication, a certain DCI may indicate up to M>1 TCI-states. The application of the TCI-states to various channels may differ based on a network provided indication to the UE on which TCI-state(s) to apply for which transmission occasion(s) or port(s) of a given channel.

In certain embodiments, the UE is configured to receive from a network node, an indicator or a parameter via the PHY-layer (e.g., via a field in a PDCCH) or a higher layer (e.g., MAC-CE message or RRC signalling) for the transmission or reception of at least one of the following channel(s) and/or reference signal(s):
PUSCH,
PDSCH,
PUCCH,
PDCCH,
SRS,
CSI-RS,
   wherein said indicator or parameter denotes/indicates which TCI-state(s) among the M≥1 TCI-states indicated/provided to the UE via one or more PDCCH(s) and/or MAC-CE message(s) by the network node, is/are applied to the port(s), resource(s) and/or transmission occasion(s) associated with said channel(s) and/or reference signal(s).

In certain embodiments, the provided/indicated M TCI-states are:
M joint TCI-states, or
M DL TCI-states and M UL TCI-states.

The M TCI-states are provided to the UE via one or more PDCCHs and/or MAC-CE messages. In certain embodiments, one or more of said M TCI-states may be updated/activated/indicated via PDCCH(s) and/or MAC-CE message(s).

In certain embodiments, the UE is configured to receive from a network node, an indicator or a parameter via the PHY-layer or a higher layer that indicates/denotes whether the UE shall apply to a CORESET or a group of CORESET(s),
the i-th of the M≥1 indicated/provided DL or joint TCI-states, where i=1, . . . , M, or
all of the M≥1 indicated/provided DL or joint TCI-states.

The parameter or indicator, if configured via a higher layer, may be configured per CORESET or a group of one or more CORESET(s).

The parameter or indicator, if provided via the PHY-layer, is a b-bit field in a PDCCH, where b≥1. The value of a field may indicate which of the indicated/provided TCI-state(s) are applied to one or more configured CORESETs or CORESET groups. For example, a value of vᵢ for said b-bit field may denote that the UE shall apply the i-th indicated TCI-state to the CORESET associated with the PDCCH or one or more CORESETs belong to the same group as the CORESET comprising said PDCCH. A value of vⱼ may denote that UE shall apply all the M indicated TCI-states to the CORESET associated with the PDCCH or one or more CORESETs belong to the same group as the CORESET comprising said PDCCH.

In certain embodiments, a CORESET group may be configured via a higher layer that comprises one or more CORESETs.

The application of multiple DL or joint TCI-states to a CORESET results in a single-frequency-network (SFN) like transmission, where multiple TRPs perform identical transmissions to the UE in identical time and frequency domain resources.

In certain embodiments, the UE is configured to receive from a network node, an indicator or a parameter via the PHY-layer or a higher layer that indicates/denotes whether the UE shall apply to a PUCCH resource, a PUCCH resource group or a PUCCH resource set,
the i-th of the M≥1 indicated/provided UL or joint TCI-states, where i=1, . . . , M, or
all of the M≥1 indicated/provided UL or joint TCI-states.

The parameter or indicator may be configured per PUCCH resource, PUCCH resource group or PUCCH resource set, if configured via a higher layer.

The parameter or indicator, if provided via the PHY-layer, is a c-bit field in a PDCCH, where ≥1. The value of a field may indicate which indicated TCI-state(s) are applied to one or more configured PUCCH resources, PUCCH resource groups or PUCCH resource sets. For example, a PDCCH may comprise a value uᵢ for the field that may mean that the UE shall apply the i-th indicated TCI-state to a PUCCH resource indicated by the PDCCH or one or more PUCCH resource(s) belonging to the same PUCCH resource group or PUCCH resource set as a PUCCH resource indicated by the PDCCH. A value of uⱼ may mean that UE shall apply all the M indicated TCI-states to a PUCCH resource indicated by the PDCCH or one or more PUCCH resource(s) belonging to the same PUCCH resource group or PUCCH resource set as a PUCCH resource indicated by the PDCCH.

The indicator or parameter determines if the PUCCH or PDCCH transmissions are performed in single-TRP or multi-TRP mode. If the indicator or parameter is configured via a higher layer such as the RRC, there is no dynamic switching (PDCCH-based or MAC-CE based switching) of the transmission modes. If provided via the PHY-layer or MAC-CE, low-latency switching between single- and multi-TRP transmission modes is possible.

In certain embodiments, the UE is configured to receive an indication from a network node on a PDCCH scheduling a PDSCH or PUSCH that indicates whether the UE shall apply,
the i-th of the M≥1 provided/indicated TCI-states, where i=1, . . . , M, or
all of the M≥1 provided/indicated TCI-states,
   to one or more of the (DMRS) port(s)/layer(s) of one or more of the transmission occasions of said PDSCH or PUSCH scheduled by said PDCCH.

It is to be noted that in the case of the PUSCH, the TCI-state(s) applied is/are UL or joint TCI-state(s) and in the case of PDSCH the TCI-state(s) applied is/are DL or joint TCI-state(s).

In certain embodiments, the size of a field in a PDCCH that indicates which of the M TCI-state(s) provided to the UE shall be applied to uplink or downlink physical channel resource(s), port(s) and/or transmission occasion(s), is equal to or greater than ┌log₂ M+1┐ bits.

In certain embodiments, said field in the PDCCH scheduling a PUSCH is an SRS resource set indicator field.

In some scenarios, a PDCCH may schedule PUSCH(s) that is/are associated with one or more SRS resource sets. The association between SRS resource set(s) and PUSCH transmission occasion(s) and/or port(s) can be controlled using an SRS resource set indicator field in the PDCCH scheduling the PUSCH(s), which may be reused to indicate which TCI-state(s) are applied to the PUSCH(s) and/or how the TCI-state(s) are mapped to the PUSCH(s).

In certain embodiments, if the indication denotes/indicates the application of the i-th of the M indicated DL or joint TCI-states, the UE shall apply said TCI-state to all or a subset of the PDSCH transmission occasion(s) scheduled by said PDCCH. In certain examples, the TCI-state shall be applied to all the (DMRS) port(s)/layer(s) of the said PDSCH transmission occasion(s).

In certain embodiments, if the indication denotes/indicates the application of the i-th of the M indicated UL of joint TCI-states, the UE shall apply said TCI-state to all or a subset of the PUSCH transmission occasion(s) scheduled by said PDCCH. In certain examples, the TCI-state shall be applied to all the (DMRS) port(s)/layer(s) of the said PUSCH transmission occasion(s).

In some examples, if the indication indicates the application of all of the M indicated TCI-states, the UE shall apply them in one or more of the following ways, which may be optionally determined based on higher layer configuration:
the M indicated TCI-states are applied to M distinct sets of port(s) and/or transmission occasion(s) of the PDSCH or PUSCH scheduled by the PDCCH, or
all the M indicated TCI-states are applied to all port(s) of all the transmission occasion(s) of the PDSCH or PUSCH scheduled by the PDCCH.

In the two choices for application of all the M indicated TCI-states presented above, the second one corresponds to a SFN mode of transmission. The other method may lead to a spatial-division, time-division and/or frequency-division multiplexing of PDSCH or PUSCH port(s) and/or transmission occasion(s) in a multiple TRP/panel/UE panel scenario.

In certain embodiments, M=2.

In certain embodiments, the mapping between M>1 TCI-states to M distinct sets of port(s) and/or transmission occasion(s) of the PDSCH or PUSCH scheduled by the PDCCH can be determined by the value of the indication (obtained either via the PHY-layer as a field in the scheduling PDCCH or obtained via higher layer indication), or is fixed in the specification. For example, when M=2, if the value of the indication is q₁, it may denote that the first TCI-state is mapped to a first set of PDSCH/PUSCH port(s) and/or transmission occasion(s) and the second TCI-state is mapped to a second set of PDSCH/PUSCH port(s) and/or transmission occasion(s). Similarly, if the value of the indication is qz, it may denote that the first TCI-state is mapped to the aforementioned second set of PDSCH/PUSCH port(s) and/or transmission occasion(s) and the second TCI-state is mapped to aforementioned first set of PDSCH/PUSCH port(s) and/or transmission occasion(s).

It is to be noted that a given transmission occasion of a PUSCH or PDSCH is associated with at least one or more DMRS ports or transmission layers, one or more symbols and one or more physical resource blocks. For two different PUSCH or PDSCH transmission occasions, there is only a partial intersection or no intersection among the following sets associated with the PDSCH/PUSCH transmission occasions:
the set of symbol(s) occupied/scheduled,
the set of physical resource block(s) occupied/scheduled
the set of DMRS port(s) associated with the transmission occasions.

With the above methods of choosing TCI-state application from a provided/indicated set of TCI-states, the switching between single-TRP and multi-TRP modes is possible via the PHY-layer or higher layer indication. However, in cases where some of the channels are not configured for multi-TRP modes, a default from the provided/indicated set of TCI-states has to be chosen.

### Default TCI-States for Single-TRP/Panel Mode in the Uplink

More often than not, there is no uniformity in the number of TRPs involved in the transmission of a channel. For instance, the DL channel(s) may operate in a multi-TRP/panel mode, while the UL may not. In some examples, only the data channels may be involved multi-TRP/panel transmissions while the control channel transmissions are associated with just a single TRP/panel. In many cases, the RRC configuration for a channel may determine if a switching between various modes is possible or not. However, for channels or RSs where only single-TRP/panel mode is enabled via RRC configuration and/or UE capability limits, default TCI-state have to be determined from a TCI-state indication scheme that is intended to involve multiple TRPs/panels. In this subsection, this issue is addressed.

In certain embodiments, a method performed by a user equipment, UE, is proposed, the method comprising:
receiving from a network node an indication of M≥1 transmission configuration indication-states, TCI-states, via physical layer and/or higher layer signaling, and
applying a single default TCI state from said M TCI-states to port(s), resource(s) and/or transmission/reception occasion(s) associated with one or more channel(s) and/or reference signal(s), wherein the chosen default TCI state is either indicated by the network or known by the UE (e.g., the default TCI state chosen by the UE is fixed in the NR specifications).

In certain embodiments, the provided/indicated M TCI-states are:
M joint TCI-states, or
M DL TCI-states and M UL TCI-states.

In certain embodiments, the M TCI-states are indicated/provided to the UE via one or more PDCCH(s) and/or MAC-CE messages.

In certain embodiments, the M TCI-states may be indicated/provided to the UE via RRC configuration. In some examples, the RRC may indicate/provide/comprise no more than M TCI-state configurations.

In certain embodiments, the UE applies a default TCI state to port(s), resource(s) and/or transmission/reception occasion(s) associated with a channel or a reference signal when there is no indication or parameter provided for said channel or reference signal via the PHY-layer or a higher layer that denotes which TCI-state(s) among the indicated/provided M≥1 TCI-states are to be applied to one or more ports, resources and/or transmission occasions associated with said channel or a reference signal.

In certain embodiments, the UE is configured to apply the default UL or joint TCI-state from the M UL or joint TCI-states indicated/provided to the UE, to all or a subset of the PUSCH transmission occasion(s) scheduled by a PDCCH. In some examples, the TCI-state shall be applied to all the (DMRS) ports of the said PUSCH transmission occasion(s). This may apply at least when M≥2.

In some examples, the method is applicable at least when the UE is either configured with only one codebook-based or non-codebook-based SRS resource set, or is not configured with two codebook-based or non-codebook-based SRS resource sets. This method may also be applicable for PUSCH that is scheduled with the default DCI format, i.e., DCI format 0_0.

In some examples, the method is applicable at least when the UE is not provided with an indicator via the PHY-layer or higher layer indicating which of the M TCI-states provided to the UE is/are applied to the PUSCH port(s) and/or PUSCH transmission occasion(s). For example, the method is applicable for PUSCH when the scheduling PDCCH either does not comprise an SRS resource set indicator field or does not comprise more than one SRS resource indicator field.

In some examples, the method is applicable at least when the UE is not configured with any multi-TRP or multi-panel scheme for PUSCH such as SFN or multi-TRP/panel spatial- and/or time-division-multiplexing schemes.

In certain embodiments, the UE is configured to apply the default UL or joint TCI-state from the M UL or joint TCI-states to one or more SRS resources, or all SRS resources of a ‘codebook’ or ‘nonCodebook’ SRS resource set. In some examples, this method is applicable at least when the UE is either configured with only one codebook-based or non-codebook-based SRS resource set, or is not configured with two codebook-based or non-codebook-based SRS resource sets.

In certain embodiments, the UE is configured to apply the default UL or joint TCI-state from the M UL or joint TCI-states to at least one PUCCH resource, PUCCH resource group or PUCCH resource set. In some examples, said PUCCH resource, PUCCH resource group or PUCCH resource set is not provided with an indicator via the PHY-layer or higher layer indicating/denoting which of the M TCI-states provided to the UE is/are applied to it/them.

In certain embodiments, the UE is configured to apply the default UL or joint TCI-state from the M UL or joint TCI-states at least to all the UE-dedicated PUCCH resources in a CC. This is applicable at least when one or all of the UE-dedicated PUCCH resources, PUCCH resource groups or PUCCH resource sets in the CC is/are not provided with an indicator via the PHY-layer or higher layer indicating/denoting which of the M TCI-states provided to the UE is/are applied to it/them.

In certain embodiments, the default TCI state is the first or second UL or joint TCI-state among the M UL or joint TCI states indicated/provided to the UE.

In certain embodiments, the index of the default TCI state (e.g., first, second, etc.) among the M UL or joint TCI states is provided by the network via higher layer signalling (e.g., RRC).

### Default TCI-States for Single-TRP Mode in the Downlink

In the above methods, the DL is configured in a multi-TRP mode, while the UL is configured in single-TRP mode. In the following, the default TCI-states for DL while the UL is in multi-TRP/panel mode are discussed.

In certain embodiments, the UE is configured to apply the default DL or joint TCI-state from the M DL or joint TCI-states indicated/provided to the UE, to all or a subset of the PDSCH transmission occasion(s) scheduled by a PDCCH. In some examples, the TCI-state shall be applied to all the (DMRS) ports of the said PDSCH transmission occasion(s). This may apply at least when M≥2.

In some examples, the method is applicable at least when the UE is not provided with any indicator via the PHY-layer or higher layer indicating/denoting which of the M TCI-states provided to the UE is/are applied to said PDSCH port(s) and/or transmission occasion(s). For example, the method is applicable at least when the scheduling PDCCH does not comprise any indication denoting which of the M TCI-states provided to the UE is/are applied to the PDSCH port(s) and/or transmission occasion(s) scheduled by the PDCCH.

In some examples, the method is applicable when the UE is not configured via a higher layer with any multi-TRP scheme for PDSCH such as SFN or multi-TRP spatial-division, frequency-division and/or time-division multiplexing schemes.

In certain embodiments, the UE is configured to apply the default DL or joint TCI-state from the M DL or joint TCI-states, to one or more CORESETs or CORESET groups. In some instances, said CORESET(s) or CORESET group(s) is/are not provided with an indication via the PHY-layer or higher layer indicating/denoting which of the M TCI-states provided to the UE is/are applied to it/them.

In some examples, none of the CORESETs or CORESET groups are provided with an indicator via the PHY-layer or higher layer indicating/denoting which of the M TCI-states provided to the UE is/are applied to it/them.

In an example, the method is applicable at least when the UE is not configured with SFN or PDCCH repetition scheme(s).

In certain embodiments, the UE is configured to apply the default DL or joint TCI-state from the M DL or joint TCI-states to one or more CSI-RS resources, or all CSI-RS resources in a CSI-RS resource set. In some instances, said CSI-RS resource(s) or CSI-RS resource set is/are not provided with any indicator via the PHY-layer or higher layer indicating/denoting which of the M TCI-states provided to the UE is/are applied to it/them.

In certain embodiments, the default TCI state is the first or second DL or joint TCI-state among the M DL or joint TCI states indicated/provided to the UE.

In certain embodiments, the index of the default TCI state (e.g., first, second, etc.) among the M DL or joint TCI states is provided by the network via higher layer signalling (e.g., RRC).

### Regulation of the Number of TCI-States Indicated Based on Multi-TRP Configuration

In some of the above methods, the TCI-states application is determined based on the configured multi-TRP mode. However, it is also possible to configure the TCI-state indication based on the multi-TRP mode configured. This would simplify the UE implementation so as to not maintain two TCI-states for the UL or DL if there is no possibility of multi-TRP transmission in the UL or DL, respectively.

In certain embodiments, the UE is configured or expects to be provided/indicated with only one UL TCI-state or joint TCI-state via one or more PDCCHs or MAC-CE messages by a network node at least in one of the following scenarios:
the UE is configured with only one codebook-based or non-codebook-based SRS resource set,
at least one or all of at least the UE dedicated PUCCH resources, PUCCH resource groups or PUCCH resource sets in the CC is/are not provided with an indicator via the PHY-layer or higher layer indicating/denoting which of the M TCI-states provided to the UE is/are applied to it/them,
the UE is not configured with SFN or multi-TRP/panel spatial- and/or time-division-multiplexing schemes.

In some examples, the UE expects to be indicated/provided via a MAC-CE message, a mapping of only one UL TCI-state to a codepoint of the TCI-state indication field in a PDCCH. In some examples, the UE expects to be indicated/provided via a MAC-CE message, an update of only the first UL TCI-state for a codepoint of the TCI-state indication field in a PDCCH that can be indicated with up to two UL TCI-states.

In certain embodiments, the UE is configured or expects to be provided/indicated with only one DL TCI-state or joint TCI-state via one or more PDCCHs or MAC-CE messages by a network node at least in one of the following scenarios:
the UE is not configured with SFN or multi-TRP/panel spatial-division, frequency-division and/or time-division multiplexing for PDSCH,
at least one or all of the CORESETs in the CC is/are not provided with an indicator via the PHY-layer or higher layer indicating/denoting which of the M TCI-states provided to the UE is/are applied to it/them,
at least one or all of the CSI-RS resource(s) or CSI-RS resource set(s) is/are not provided with any indicator via the PHY-layer or higher layer indicating/denoting which of the M TCI-states provided to the UE is/are applied to it/them.

In some examples, the UE expects to be indicated/provided via a MAC-CE message, a mapping of only one DL TCI-state to a codepoint of the TCI-state indication field in a PDCCH. In some examples, the UE expects to be indicated/provided via a MAC-CE message, an update of only the first DL TCI-state for a codepoint of the TCI-state indication field in a PDCCH that can be indicated with up to two DL TCI-states.

The restrictions for the MAC-CE message help the UE to not track a second TCI-state or receive any updates for it, if there is no multi-TRP mode configured, thereby simplifying UE implementation.

MULTI-DCI-Based Multi-TRP TCI-State Indication with Co-Existence

In this method of TCI-state indication, the segregation of various channels and RSs using one or more indices can be performed, as discussed in length in the disclosure above. An issue regarding co-existence similar to the ones discussed for single-DCI-based multi-TRP above is that of multi-DCI-based multi-TRP with a single SRS resource set configured in the UL. The following methods described above can already be used for such purposes:
Association of the SRS resource(s) in the SRS resource set or the SRS resource set itself with a default value of a TCI-update-Index or a CORESET pool index,
Association of the SRS resource(s) in the SRS resource set or the SRS resource set itself with a value of a TCI-update-Index or a CORESET pool index via explicit signalling from the network, and/or
Association of the SRS resource(s) in the SRS resource set or the SRS resource set itself with a value of a TCI-update-Index or a CORESET pool index associated with the PDCCH scheduling or triggering the SRS.

All these methods give rise to various possibilities of UL precoding/beamforming. The association via explicit signalling means that the UL transmission may be directed by the network towards TRP of its choice. The association via the PDCCH means that the beamforming of aperiodic SRS transmissions can be controlled by the network via PDCCH scheduling. Finally, by associating with a default value, the UL transmissions are always directed towards a single TRP. All three are valid solutions and may be used for various time domain behaviours of SRS.

A second solution would be to simply configure multiple SRS resource sets when multiple CORESET pool index values are involved.

In certain embodiments, the UE is configured with S>1 SRS resource sets at least under one of the following conditions:
for at least two different CORESETs in a CC, the associated values of an index (e.g., CORESET pool index) are different,
for at least one CORESET in a CC, the value of an index (e.g., CORESET pool index) associated with it is not equal to 0.

In certain embodiments, the value of S is two.

In certain embodiments, the SRS resource sets are codebook-based or non-codebook-based SRS resource sets.

In certain embodiments, a first SRS resource set with an index/identifier/ID with the lower value among the two SRS resource sets is associated with a value zero of an index (e.g., CORESET pool index) and the other SRS resource set is associated with a value one of said index.

In certain embodiments, the UE is configured to receive a PDCCH for the scheduling/activation of one or more PUSCH transmission occasions wherein, the SRS resource set associated with the SRS resource indicator field in the scheduling PDCCH, or the SRS resource set associated with the PUSCH transmission occasion(s), is the one that is associated with the same value of the index (e.g., CORESET pool index) as that of the CORESET carrying/comprising the PDCCH.

In certain embodiments, the UE is configured to receive a triggering/activation/scheduling of an SRS resource set via a PDCCH, wherein the PDCCH that is associated with the same value of the index (e.g., CORESET pool index) as the SRS resource set. In some examples, this restriction is strictly applied, i.e., only a PDCCH associated with the same value of the index (e.g., CORESET pool index) as an SRS resource set, can trigger/activate/schedule said SRS resource set. This restriction can be provided in the specification as a rule.

In certain embodiments, an indication of Q≥1 TCI-states via a PHY-layer (PDCCH/DCI) or higher layer signaling (e.g., MAC-CE or RRC) implies the indication of one of the following in one transmission occasion or instance of said PHY-layer or higher layer signaling:
Q downlink TCI-state(s),
Q uplink TCI-state(s),
Q_{D}≥1 downlink TCI-states(s) and Q_{U}≥1 uplink TCI-states, wherein
   Q_{D}=Q_{U}=Q, (for e.g., Q pairs of TCI-states, each pair comprising an UL TCI-state and a DL TCI-state), or
   Q_{D}=Q and Q_{U}<Q, or
   Q_{U}=Q and Q_{D}<Q
Q TCI-state(s) that jointly provide downlink and uplink setting(s), i.e., joint TCI state(s).

In certain embodiments, a method performed by a user equipment, UE, is proposed, the method comprising:
receiving from a network node an indication of M≥1 transmission configuration indication-states, TCI-states, via physical, PHY, layer and/or higher layer signaling, and
applying a default TCI state from said M TCI-states to port(s), resource(s), transmission and/or reception occasion(s) associated with one or more channel(s) and/or reference signal(s).

In certain embodiments, the index of the default TCI state among said M TCI-state(s) is either indicated by the network node or known by the UE and fixed in the NR specifications.

In certain embodiments, the provided or indicated M TCI-states are M joint TCI-states, or M DL TCI-states and M UL TCI-states.

In certain embodiments, the M TCI-states are indicated to the UE via one or more PDCCH(s) and/or MAC-CE messages.

In certain embodiments, the M TCI-states are indicated or provided to the UE via RRC configuration, and wherein the RRC provides no more than M TCI-state configurations.

In certain embodiments, the default TCI state is applied to port(s), resource(s), transmission occasion(s) and/or reception occasion(s) associated with a channel or a reference signal when there is no indication or parameter provided for said channel or reference signal that denotes which TCI-state(s) among the M TCI-states is/are applied to one or more port(s), resource(s), transmission occasion(s) and/or reception occasion(s) associated with said channel or reference signal.

In certain embodiments, the default TCI state is a UL or joint TCI-state from one of M UL or joint TCI-states.

In certain embodiments, the default TCI state is applied to at least one of the following:
all or a subset of the PUSCH transmission occasion(s) scheduled by a PDCCH, or
one or more SRS resources, or all SRS resources of a ‘codebook’ or ‘nonCodebook’ SRS resource set, or
one or more PUCCH resource, PUCCH resource group or PUCCH resource set.

In certain embodiments, the UE is configured with only one codebook-based or non-codebook-based SRS resource set or not configured with two codebook-based or non-codebook-based SRS resource sets.

In certain embodiments, the scheduling PDCCH does not comprise an SRS resource set indicator field or more than one SRS resource indicator field.

In certain embodiments, the default TCI state is the first or second UL or joint TCI-state among the M UL or joint TCI states.

In certain embodiments, the default TCI state is a DL or joint TCI-state from one of M DL or joint TCI-states indicated or provided to the UE.

In certain embodiments, the default TCI state is applied to at least one of the following:
all or a subset of the PDSCH transmission occasion(s) scheduled by a PDCCH, or
one or more CORESETs, or CORESET groups, or
one or more CSI-RS resources, CSI-RS resource sets.

In certain embodiments, the default TCI state is the first or second DL or joint TCI-state among the M DL or joint TCI states.

In certain embodiments, the UE is configured with two codebook-based or non-codebook-based SRS resource sets at least under one of the following conditions:
for at least two different CORESETs in a CC, the associated values of the index (e.g., CORESET pool index) are different,
for at least one CORESET in a CC, the value of the index (e.g., CORESET pool index) associated with it is not 0.

In certain embodiments, a first SRS resource set with an index/identifier/ID with the lower value among the two SRS resource sets is associated with a value zero of said index and the other SRS resource set is associated with a value one of said index.

In certain embodiments, the UE is configured to receive a PDCCH for the scheduling/activation of one or more PUSCH transmission occasions wherein, the SRS resource set associated with the SRS resource indicator field in the scheduling PDCCH or the SRS resource set associated with the PUSCH transmission occasion(s), is the one that is associated with the same value of the index (e.g., CORESET pool index) as that of the CORESET carrying/comprising the PDCCH.

In certain embodiments, the UE is configured to receive a triggering/activation of an SRS resource set via a PDCCH, wherein the PDCCH is associated with the same value of the index (e.g., CORESET pool index) as the SRS resource set.

In certain embodiments, a method performed by a network node is proposed, the method comprising:
transmitting to a user equipment, M≥1 transmission configuration indication-states, TCI-states, via physical, PHY, layer and/or higher layer signaling, and
for enabling the UE to apply a default TCI state from said M TCI-states to port(s), resource(s), transmission and/or reception occasion(s) associated with one or more channel(s) and/or reference signal(s).

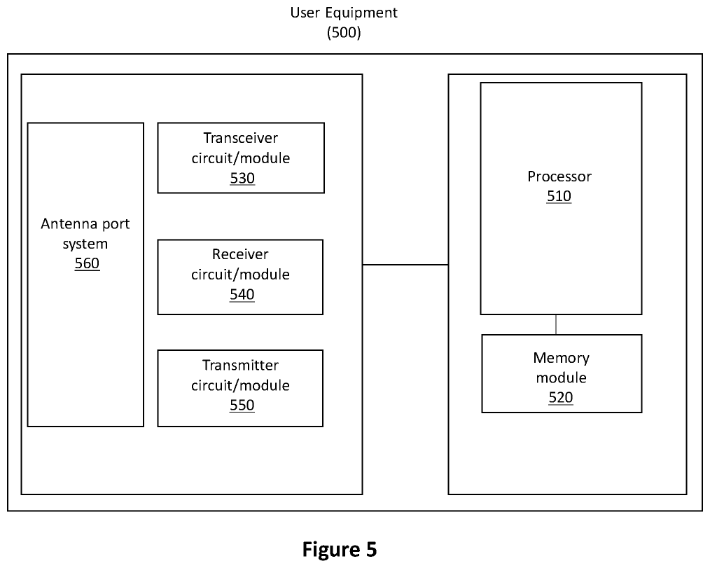

In order to perform the previously described processes or methods related to the UE, there is also provided a UE. FIG. 5 illustrates a block diagram depicting the UE 500. The UE 500 comprises a processor 510 or processing circuit or a processing module or a processor or means for processing; a receiver circuit or receiver module 540; a transmitter circuit or transmitter module 550; a memory module 520, a transceiver circuit or transceiver module 530 which may include the transmitter circuit 550 and the receiver circuit 540. The UE 500 further comprises an antenna system 560 which includes antenna circuitry for transmitting and receiving signals, the antenna system may employ beamforming.

The UE 500 may belong to any radio access technology including 4G or LTE, LTE-A, 5G, etc. that support beamforming technology. The UE comprising the processor 510 and the memory 520 which contains instructions executable by the processor 510, whereby the UE 500 is operative/configured to perform any one of the subject-matter of claims 1-40 or any one of the subject-matter of previously described embodiments.

The UE 500 is configured or is operative to: receive from a network node, an indication of one or more transmission configuration indication (TCI) state(s) comprising one or more transmission and/or reception setting(s) for one or more uplink (UL) and/or downlink (DL) channel(s), channel resource(s) and/or reference signal(s), via one or more physical (PHY) layer or higher layer signaling. The UE 500 is configured or is operative to receive from the network node or to perform an association of one or more UL and/or DL channel(s), channel resource(s) and/or reference signal(s) with value(s) of an index or parameter, wherein a UL or DL channel or channel resource or reference signal is associated with a value of said index or parameter, and—the UE 500 is configured or is operative to updated or apply at least one transmission and/or reception setting in a TCI-state for a group of one or more UL and/or DL channel(s), channel resource(s) and/or RS(s) that are associated with the same value of the index or parameter.

According to other embodiments, the UE 500 is configured or is operative to: receive from a network node, an indication of one or, TCI state(s) comprising one or more transmission and/or reception setting(s) for one or more UL and/or DL channel(s), channel resource(s) and/or reference signal(s), via one or more physical, PHY, layer or higher layer signaling. The UE 500 is configured to receive from the network node or to perform an association of one or more UL and/or DL channel(s), channel resource(s) and/or reference signal(s), RS(s), with value(s) of two or more indices or parameters, wherein a UL or DL channel or channel resource or reference signal is associated with a value of an index or parameter, and to update or apply at least one transmission and/or reception setting in a TCI-state for a first group of one or more UL and/or DL channel(s), channel resource(s) and/or RS(s) associated with a first value of a first index and a second group of one or more UL and/or DL channel(s), channel resource(s) and/or RS(s) associated with a second value of a second index.

According to other embodiments, the UE 500 is configured to or is operative to: receive from a network node M≥1 TCI-states, via a PDCCH, or a higher layer signaling, and to apply the M TCI-states to:
one or more transmission occasions, or one or more parts of a transmission occasion of one or more physical channels, according to a predetermined or indicated mapping of the TCI-states and said transmission occasion(s) or part(s) of said one transmission occasion, wherein said physical channel transmission(s) is/are scheduled by a PDCCH or higher layer signaling different from the PDCCH or higher layer signaling providing the TCI-state indication, and/or
one or more reference signal (RS) resources or resource sets according to a predetermined or indicated mapping of the TCI-states with said resources or resource sets.

The processing module/circuit of the UE 500 includes a processor, microprocessor, an application specific integrated circuit (ASIC), field programmable gate array (FPGA), or the like, and may be referred to as the “processor.” The processor controls the operation of the UE 500 and its components. Memory (circuit or module) includes a random-access memory (RAM), a read only memory (ROM), and/or another type of memory to store data and instructions that may be used by processor. In general, it will be understood that the UE 500 in one or more embodiments includes fixed or programmed circuitry that is configured to carry out the operations in any of the embodiments disclosed herein.

There is also provided a computer program comprising instructions which when executed by the processor of the UE 500 cause the processor 510 to carry out the method according to any one of claims 1-40.

In at least one such example, the UE 500 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure. Further, it will be appreciated that the UE 500 may comprise additional components.

Additional details on the functions and operations performed by the UE have already been described and need not be repeated. The functions or operations of the UE 500 are further disclosed in the appended claims.

There is also provided a method performed by a network node. The method comprising: transmitting to a UE an indication of one or more TCI state(s) comprising one or more transmission and/or reception setting(s) for one or more UL and/or DL channel(s), channel resource(s) and/or reference signal(s), via one or more PHY layer or higher layer signaling. The method further comprises, transmitting to the UE an association of one or more UL and/or DL channel(s), channel resource(s) and/or reference signal(s) with value(s) of an index or parameter, wherein an UL or DL channel or channel resource or reference signal is associated with a value of said index or parameter; for enabling the UE to update or apply at least one transmission and/or reception setting in a TCI-state for a group of one or more UL and/or DL channel(s), channel resource(s) and/or RS(s) that are associated with the same value of the index or parameter.

There is also provided another method performed by the network node. The method comprising: transmitting to a UE an indication of one or more TCI state(s) comprising one or more transmission and/or reception setting(s) for one or more UL and/or DL channel(s), channel resource(s) and/or reference signal(s), via one or more PHY layer or higher layer signaling. The method further comprises, transmitting to the UE an association of one or more UL and/or DL channel(s), channel resource(s) and/or reference signal(s), RS(s), with value(s) of two or more indices or parameters, wherein an UL or DL channel or channel resource or reference signal is associated with a value of an index or parameter; for enabling the UE to update or apply at least one transmission and/or reception setting in a TCI-state for a first group of one or more UL and/or DL channel(s), channel resource(s) and/or RS(s) associated with a first value of a first index and a second group of one or more UL and/or DL channel(s), channel resource(s) and/or RS(s) associated with a second value of a second index.

There is also provided another method performed by a network node. The method comprising: transmitting to a UE M≥1 TCI-states, via a PDCCH, or a higher layer signaling, for enabling the UE to apply the M TCI-states to:
one or more transmission occasions, or one or more parts of a transmission occasion of one or more physical channels, according to a predetermined or indicated mapping of the TCI-states and said transmission occasion(s) or part(s) of said one transmission occasion, wherein said physical channel transmission(s) is/are scheduled by a PDCCH or higher layer signaling different from the PDCCH or higher layer signaling providing the TCI-state indication, and/or
one or more reference signal, RS, resources, or resource sets according to a predetermined or indicated mapping of the TCI-states with said resources or resource sets.

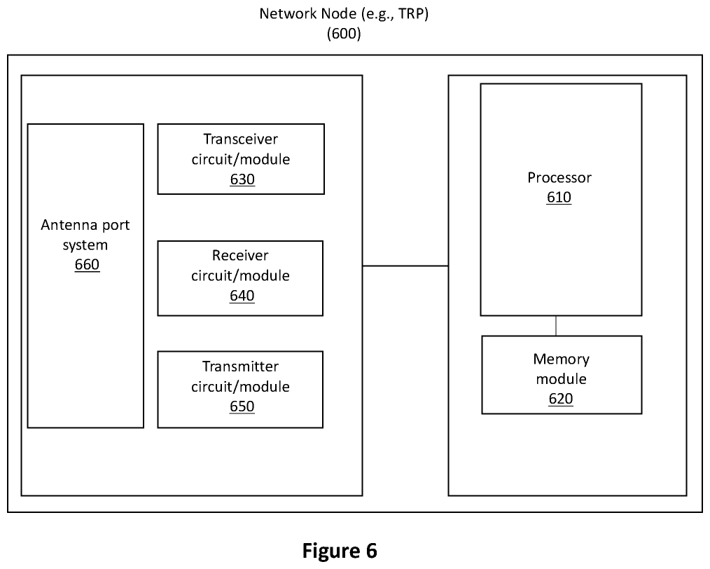

In order to perform the previously described processes or methods related to the network node, there is also provided a network node. FIG. 6 illustrates a block diagram depicting the network node 600. The network node 600 comprises a processor 610 or processing circuit or a processing module or a processor or means for processing; a receiver circuit or receiver module 640; a transmitter circuit or transmitter module 650; a memory module 620, a transceiver circuit or transceiver module 630 which may include the transmitter circuit 650 and the receiver circuit 640. The network node 600 further comprises an antenna system 660 which includes antenna circuitry for transmitting and receiving signals, the antenna system may employ beamforming.

The network node 600 may belong to any radio access technology including 4G or LTE, LTE-A, 5G, etc. that support beamforming technology. The network node comprising the processor 610 and the memory 620 which contains instructions executable by the processor 610, whereby the network node 600 is operative/configured to perform any one of the subject-matter of claim 42-44 or any one of the subject-matter of previously described embodiments.

The network node 600 is configured or is operative to: transmit to a UE an indication of one or more TCI state(s) comprising one or more transmission and/or reception setting(s) for one or more UL and/or DL channel(s), channel resource(s) and/or reference signal(s), via one or more PHY layer or higher layer signaling. The network node 600 is further configured or operative to transmit to the UE an association of one or more UL and/or DL channel(s), channel resource(s) and/or reference signal(s) with value(s) of an index or parameter, wherein a UL or DL channel or channel resource or reference signal is associated with a value of said index or parameter; for enabling the UE to update or apply at least one transmission and/or reception setting in a TCI-state for a group of one or more UL and/or DL channel(s), channel resource(s) and/or RS(s) that are associated with the same value of the index or parameter.

According to some embodiments, the network node 600 is configured or is operative to: transmit to a UE an indication of one or more TCI state(s) comprising one or more transmission and/or reception setting(s) for one or more UL and/or DL channel(s), channel resource(s) and/or reference signal(s), via one or more PHY layer or higher layer signaling. The network node is further configured or operative to transmit to the UE an association of one or more UL and/or DL channel(s), channel resource(s) and/or reference signal(s), RS(s), with value(s) of two or more indices or parameters, wherein a UL or DL channel or channel resource or reference signal is associated with a value of an index or parameter; for enabling the UE to update or apply at least one transmission and/or reception setting in a TCI-state for a first group of one or more UL and/or DL channel(s), channel resource(s) and/or RS(s) associated with a first value of a first index and a second group of one or more UL and/or DL channel(s), channel resource(s) and/or RS(s) associated with a second value of a second index.

According to some embodiments, the network node 600 is configured or is operative to: transmit to a UE M≥1 TCI-states, via a PDCCH, or a higher layer signaling, for enabling the UE to apply the M TCI-states to:
one or more transmission occasions, or one or more parts of a transmission occasion of one or more physical channels, according to a predetermined or indicated mapping of the TCI-states and said transmission occasion(s) or part(s) of said one transmission occasion, wherein said physical channel transmission(s) is/are scheduled by a PDCCH or higher layer signaling different from the PDCCH or higher layer signaling providing the TCI-state indication, and/or
one or more reference signal, RS, resources, or resource sets according to a predetermined or indicated mapping of the TCI-states with said resources or resource sets.

Additional functions or operations performed by the network node have already been described and need not be repeated.

The processing module/circuit of the network node 600 includes a processor, microprocessor, an application specific integrated circuit (ASIC), field programmable gate array (FPGA), or the like, and may be referred to as the “processor.” The processor controls the operation of the network node 600 and its components. Memory (circuit or module) includes a random-access memory (RAM), a read only memory (ROM), and/or another type of memory to store data and instructions that may be used by processor. In general, it will be understood that the network node 600 in one or more embodiments includes fixed or programmed circuitry that is configured to carry out the operations in any of the embodiments disclosed herein.

There is also provided a computer program comprising instructions which when executed by the processor of the network node 600 cause the processor 610 to carry out the method according to any one of claims 42-44

In at least one such example, the network node 600 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure. Further, it will be appreciated that the network node may comprise additional components.

Throughout this disclosure, the word “comprise” or “comprising” has been used in a non-limiting sense, i.e., meaning “consist at least of”. Although specific terms may be employed herein, they are used in a generic and descriptive sense only and not for purposes of limitation. As described, the embodiments herein may be applied in any wireless systems including LTE or 4G, LTE-A (or LTE-Advanced), 5G, WiMAX, WiFi, satellite communications, TV broadcasting etc. that may employ beamforming technology.

1-65. (canceled)

66. A method performed by a user equipment (UE), the method comprising:
receiving, from a network node via a physical downlink control channel (PDCCH) or a higher layer signaling, a transmission configuration indication (TCI)-state indication for M TCI-states, where M>1; and
applying the M TCI-states to:
one or more transmission occasions of a physical channel or one or more parts of a transmission occasion of a physical channel according to a predetermined or indicated mapping of the M TCI-states to the one or more transmission occasions or the one or more parts of the transmission occasion, wherein the one or more transmission occasions of the physical channel or the one or more parts of the transmission occasion of the physical channel are scheduled by a scheduling PDCCH or a scheduling higher layer signaling that is different from the PDCCH or the higher layer signaling; or
one or more reference signal (RS) resources or one or more RS resource sets according to a predetermined or indicated mapping of the M TCI-states with the one or more RS resources or the one or more RS resource sets.

67. The method according to claim 66, wherein at least one part of one or more parts of the transmission occasion of the physical channel is associated with one or more different ports or frequency-domain resources or time domain resources from at least one other part of the transmission occasion of the physical channel.

68. The method according to claim 66, wherein the physical channel is a physical downlink shared channel (PDSCH) or a physical uplink shared channel (PUSCH), or an RS resource of the one or more RS resources is a physical uplink control channel (PUCCH) resource.

69. The method according to claim 68, wherein the M TCI-states are applied to N repetitions of the PUCCH resource according to a predetermined or indicated mapping of the M TCI-states to the N repetitions, where N≥M.

70. The method according to claim 66, comprising receiving or performing an association of one or more uplink (UL) channels, one or more downlink (DL) channels, one or more RS resources, or one or more RS resource sets with values of one or more indices or one or more parameters, wherein at least one of an UL channel, a DL channel, an RS resource or an RS resource set is associated with a value of an index or a parameter.

71. The method according to claim 66, wherein the physical channel, or the one or more RS resources or resource sets to which the M TCI-states are applied, and the scheduling PDCCH or the scheduling higher layer signaling are:
associated with a same value of an index, or
associated with different indices, wherein there is a mapping between a value of an index of the scheduling PDCCH or the scheduling higher layer signaling and a value of an index of the physical channel or the one or more RS resources or resource sets to which the M TCI-states are applied.

72. The method according to claim 66, comprising:
receiving a first TCI-state indication from a first PDCCH, a Medium Access Control-Control Element (MAC-CE) message, or a first higher layer signaling, and receiving a scheduling or an indication, via one or more second PDCCHs or one or more second higher layer signalings, of at least one of the following:
a physical uplink shared channel (PUSCH) transmission occasion, a PUCCH transmission occasion, or a physical downlink shared channel (PDSCH) transmission occasion; or
a Channel State Information Reference Signal (CSI-RS), a sounding reference signal (SRS), or a synchronization signal block (SSB) resource or resource sets; and
applying TCI-states from the first TCI-state indication from the first PDCCH, the MAC-CE message, or the first higher layer signaling to one or more physical channel transmissions or RS resources or resource sets scheduled by the one or more second PDCCHs or the one or more second higher layer signalings.

73. The method according to claim 66, wherein:
a first TCI-state of the M TCI-states is applied to a part of a physical downlink shared channel (PDSCH) transmission associated with a first set of demodulation reference signal (DMRS) ports associated with a first code-division-multiplexing (CDM) group, and a second TCI-state of the M TCI-states is applied to a part of a PDSCH transmission associated with a second set of DMRS ports associated with a second CDM group; or
a first TCI-state of the M TCI-states is applied to a first PDSCH transmission occasion associated with a first set of time or frequency domain resources and a second TCI-state of the M TCI-states is applied to a second PDSCH transmission occasion associated with a second set of time or frequency domain resources that are distinct from the first set of time or frequency resources; or
a first TCI-state of the M TCI-states is applied to a first transmission occasion of a physical uplink shared channel (PUSCH) associated with a first sounding reference signal (SRS) resource indicator value or a first SRS resource set, and a second TCI-state of the M TCI-states is applied to a second transmission occasion of a PUSCH associated with a second SRS resource indicator value or a second SRS resource set; or
a first TCI-state of the M TCI-states is applied to a first transmission occasion of a PUCCH resource associated with a first set of time or frequency domain resources, and a second TCI-state of the M TCI-states is applied to a second transmission occasion of the same PUCCH resource associated with a second set of time or frequency domain resources that are distinct from the first set of time or frequency resources.

74. The method according to claim 66, comprising receiving a higher layer signaling indicating at least one of the following:
two or more physical downlink shared channel (PDSCH) transmission occasions, that are separated in time or frequency and are associated with two or more TCI-states of the M TCI-states, wherein the two or more TCI-states of the M TCI-states are obtained from a PDCCH or a higher layer signaling that is different from signaling that schedules the two or more PDSCH transmission occasions;
one or more PDSCH transmission occasions, wherein each PDSCH transmission occasion is associated with two or more TCI-states of the M TCI-states, wherein the two or more TCI-states of the M TCI-states are obtained from signaling that is different from signaling that schedules the one or more PDSCH transmission occasions; and
two or more PUSCH transmission occasions that are separated in time or frequency that are associated with two or more TCI-states of the M TCI-states, wherein the two or more TCI-states of the M TCI-states are obtained from signaling that is different from signaling that schedules the two or more PUSCH transmission occasions.

75. The method according to claim 66, wherein applying the M TCI-states comprises applying a first TCI-state of the M TCI-states to at least one sounding reference signal (SRS) resource in a first SRS resource set and a second TCI-state of the M TCI-states to at least one SRS resource in a second SRS resource set.

76. The method according to claim 66, wherein an indication of Q≥1 TCI-states via a physical layer or a higher layer signaling indicates one of the following in one transmission occasion or an instance of the physical layer or the higher layer signaling:
Q downlink TCI-states,
Q uplink TCI-states,
Q_{D}≥1 downlink TCI-states and Q_{U}≥1 uplink TCI-states,
Q_{D}=Q_{U}=Q,
Q_{D}=Q and Q_{U}<Q, or
Q_{U}=Q and Q_{D}<Q; or
Q TCI-states that jointly provide downlink and uplink settings.

77. The method according to claim 70 wherein performing the association of the one or more UL channels, the one or more DL channels, one or more RS resources, or one or more RS resource sets comprises performing the association with a default value of an index or parameter.

78. The method according to claim 70, wherein the association of the one or more UL channels, the one or more DL channels, the one or more RS resources, or the one or more RS resource sets with the values of the one or more indices or the one or more parameters is performed in one of the following ways:
via a physical layer or a higher layer signaling from the network node;
via a value of an index or a parameter associated with a PDCCH that schedules or indicates or triggers a transmission of at least one of the one or more UL channels, at least one of the one or more DL channels, at least one of the one or more RS resources, or at least one of the one or more RS resource sets; or
via a value of an index or a parameter associated with another physical channel scheduled in a same carrier component (CC) as that of the physical channel, the one or more RS resources or the one or more RS resource sets.

79. The method according to claim 66, wherein M≥2;
wherein applying the M TCI-states comprises applying a first indicated TCI-state of the M TCI-states to the physical channel, the one or more RS resources, or the one of more RS resource sets that are associated with a pre-determined or an indicated first value of the index, and applying a second indicated TCI-state of the M TCI-states to the physical channel, the one or more RS resources, or the one or more RS resource sets that are associated with a pre-determined or an indicated second value of the index.

80. The method according to claim 66, wherein one or more TCI-states of the M TCI-states are indicated or comprised in a Medium Access Control-Control Element (MAC-CE) message or the higher layer signaling that is associated with a value of an index or a parameter.

81. The method according to claim 66, wherein the PDCCH providing the TCI-state indication or the scheduling PDCCH that schedules or indicates a physical downlink shared channel (PDSCH) resource, a physical uplink shared channel (PUSCH) resource, or a PUCCH resource are associated with one or more UE-specific search space sets or one or more control resource sets (CORESETs) that are associated with at least one UE-specific search space set.

82. A user equipment (UE) comprising a processor and a memory containing instructions executable by the processor whereby the UE is operative to:
receive, from a network node via a physical downlink control channel (PDCCH) or a higher layer signaling, a transmission configuration indication (TCI)-state indication for M TCI-states, where M>1; and
apply the M TCI-states to:
one or more transmission occasions of a physical channel or one or more parts of a transmission occasion of a physical channel according to a predetermined or indicated mapping of the M TCI-states to the one or more transmission occasions or the one or more parts of the transmission occasion, wherein the one or more transmission occasions of the physical channel or the one or more parts of the transmission occasion of the physical channel are scheduled by a scheduling PDCCH or a scheduling higher layer signaling that is different from the PDCCH or the higher layer signaling; or
one or more reference signal (RS) resources or one or more RS resource sets according to a predetermined or indicated mapping of the M TCI-states with the one or more RS resources or the one or more RS resource sets.

83. A method performed by a network node, the method comprising:
transmitting, to a user equipment (UE) via a physical downlink control channel (PDCCH) or a higher layer signaling, a transmission configuration indication (TCI)-state indication for M TCI-states, where M>1, for enabling the UE to apply the M TCI-states to:
one or more transmission occasions of a physical channel or one or more parts of a transmission occasion of a physical channel according to a predetermined or indicated mapping of the M TCI-states to the one or more transmission occasions or the one or more parts of the transmission occasion, wherein the one or more transmission occasions of the physical channel or the one or more parts of the transmission occasion of the physical channel are scheduled by a scheduling PDCCH or a scheduling higher layer signaling that is different from the PDCCH or the higher layer signaling; or
one or more reference signal (RS) resources or one or more RS resource sets according to a predetermined or indicated mapping of the M TCI-states with the one or more RS resources or the one or more RS resource sets.

84. A network node comprising a processor and a memory containing instructions executable by the processor whereby the network node is operative to:
transmit, to a user equipment (UE) via a physical downlink control channel (PDCCH) or a higher layer signaling, a transmission configuration indication (TCI)-state indication for M TCI-states, where M>1, for enabling the UE to apply the M TCI-states to:
one or more transmission occasions of a physical channel or one or more parts of a transmission occasion of a physical channel according to a predetermined or indicated mapping of the M TCI-states to the one or more transmission occasions or the one or more parts of the transmission occasion, wherein the one or more transmission occasions of the physical channel or the one or more parts of the transmission occasion of the physical channel are scheduled by a scheduling PDCCH or a scheduling higher layer signaling this is different from the PDCCH or the higher layer signaling; or
one or more reference signal (RS) resources or one or more RS resource sets according to a predetermined or indicated mapping of the M TCI-states with the one or more RS resources or the one or more RS resource sets.
